(19) United States
(12) Patent Application Publication
(10) Pub. No.: US 2016/0124599 A1
(43) Pub. Date: May 5, 2016

(54) METHOD FOR CONTROLLING MULTI DISPLAY AND ELECTRONIC DEVICE THEREOF

(71) Applicant: Samsung Electronics Co., Ltd., Gyeonggi-do (KR)

(72) Inventors: Jae-Seok JOO, Gyeonggi-do (KR); Doo-Suk KANG, Gyeonggi-do (KR); Su-Young PARK, Gyeonggi-do (KR)

(21) Appl. No.: 14/922,594

(22) Filed: Oct. 26, 2015

(30) Foreign Application Priority Data
Nov. 5, 2014 (KR) 10-2014-0152966

(51) Int. Cl. G06F 3/0486; G06F 3/14; G06F 3/0482; G06F 3/0488; G06F 1/16; G06F 3/041

(52) U.S. Cl. CPC G06F 3/0486; G06F 1/1641; G06F 1/1643; G06F 1/1647; G06F 3/0412; G06F 3/0482; G06F 3/04883; G06F 3/1423

(57) ABSTRACT

A method and electronic device are disclosed. The electronic device includes a processor for controlling multiple displays, configured to detect a selection of an object displayed on a first display operatively coupled to the electronic device, and display a virtual object on a second display operatively coupled to the electronic device in response to the selection, detect a dragging of the selected object on the first display, moving the virtual object on the second display in response to the detected dragging; and, if a release of the dragged selected object is detected on the first display, move or copy the object to the second display.

### CLAIM OF PRIORITY

This application claims the benefit under 35 U.S.C. §119(a) of a Korean patent application filed on Nov. 5, 2014 in the Korean Intellectual Property Office and assigned Serial number 10-2014-0152966, the entire disclosure of which is hereby incorporated by reference.

### TECHNICAL FIELD

Various example embodiments of the present disclosure relate to a method for controlling a multi display and an electronic device thereof.

### BACKGROUND

In recent years, various types of electronic devices have been developed and found widespread use. For example, various electronic devices include wearable types such as a smart-watch or smart-glasses, as well as smartphones, tablet Personal Computers (PC), and a laptop computers, all of which are becoming increasingly popular.

The electronic device can have two or more displays, or can network (e.g., communicate wireless or by wired connection) with another electronic device to implement a multi display function. For example, an electronic device such as a smartphone can have a first display and a second display, which are physically separate. The first display and the second display can be touch screen displays.

The first display can display a screen running a first application (e.g., a photo preview application), and the second display can display a screen running a second application (e.g., a chatting service application).

A user of the electronic device may desire to, after touching any one object (e.g., a photo, an icon, and a file) displayed on the first display, perform any operation of, for example, moving, copying, or inserting, through a drag and drop operation, the object to any position of the second display (e.g., any position within applications such as a chatting service screen).

However, because the first display and the second display are physically separated, there is a problem that a continuous drag operation is cut off at a boundary point between the first display and the second display.

### SUMMARY

Various example embodiments of the present disclosure provide a multi display control method and an electronic device thereof for, when operatively connecting two or more physically separated displays with one another and using them as a multi display, naturally performing or executing moving, copying, and/or inserting an object from one display to another display through a drag and drop operation.

In one example embodiment of the present disclosure, a method for an electronic device is disclosed, including: detecting, by a processor of the electronic device, a selection of an object displayed on a first display operatively coupled to the electronic device and displaying a virtual object on a second display operatively coupled to the electronic device in response to the selection, detecting a dragging of the selected object on the first display, and moving the virtual object on the second display in response to the detected dragging, and if a release of the dragged selected object is detected on the first display moving or copying the object to the second display.

In another aspect of the present disclosure, an electronic device is disclosed, including a processor for controlling multiple displays, configured to: detect a selection of an object displayed on a first display operatively coupled to the electronic device, and display a virtual object on a second display operatively coupled to the electronic device in response to the selection, detect a dragging of the selected object on the first display, moving the virtual object on the second display in response to the detected dragging; and if a release of the dragged selected object is detected on the first display, move or copy the object to the second display.

### BRIEF DESCRIPTION OF THE DRAWINGS

The present disclosure will become more apparent from the following detailed description when taken in conjunction with the accompanying drawings in which:

FIG. 1 is a diagram illustrating an electronic device use environment according to various example embodiments of the present disclosure;

FIG. 2A and FIG. 2B are diagrams illustrating a display control module and a display according to various example embodiments of the present disclosure;

FIG. 3 is a diagram illustrating an appearance of an electronic device according to various example embodiments of the present disclosure;

FIG. 4 is a block diagram illustrating hardware of an electronic device according to various example embodiments of the present disclosure;

FIG. 5 is a diagram illustrating a multi display control method of an electronic device according to various example embodiments of the present disclosure;

FIG. 6 is a flowchart illustrating an operation of a multi display control method according to various example embodiments of the present disclosure;

FIG. 7 is a diagram illustrating a virtual object display method according to various example embodiments of the present disclosure;

FIG. 8 is another diagram illustrating a virtual object display method according to various example embodiments of the present disclosure;

FIG. 9 is another flowchart illustrating an operation of a multi display control method according to various example embodiments of the present disclosure;

FIG. 10 is an illustrative diagram displaying a virtual object at a different rate according to various example embodiments of the present disclosure;

FIG. 11 is another diagram illustrating a multi display control method of an electronic device according to various example embodiments of the present disclosure;

FIG. 12 is a further diagram illustrating a multi display control method of an electronic device according to various example embodiments of the present disclosure;

FIG. 13 is a yet another diagram illustrating a multi display control method of an electronic device according to various example embodiments of the present disclosure;

FIG. 14 is a still another diagram illustrating a multi display control method of an electronic device according to various example embodiments of the present disclosure;

FIG. 15 is a still another diagram illustrating a multi display control method of an electronic device according to various example embodiments of the present disclosure;

FIG. 16 is a still another diagram illustrating a multi display control method of an electronic device according to various example embodiments of the present disclosure;

FIG. 17 is a still another diagram illustrating a multi display control method of an electronic device according to various example embodiments of the present disclosure;

FIG. 18 is a still another diagram illustrating a multi display control method of an electronic device according to various example embodiments of the present disclosure;

FIG. 19 is a still another diagram illustrating a multi display control method of an electronic device according to various example embodiments of the present disclosure;

FIG. 20 is a still another diagram illustrating a multi display control method of an electronic device according to various example embodiments of the present disclosure; and

FIG. 21 and FIG. 22 are illustrative diagrams in which a plurality of displays operatively interwork with one another in accordance with various example embodiments of the present disclosure.

### DETAILED DESCRIPTION

Various embodiments of the present disclosure will be described herein below with reference to the accompanying drawings. In describing the present disclosure, well-known functions or implementations are not described in detail since they would obscure the disclosure in unnecessary detail.

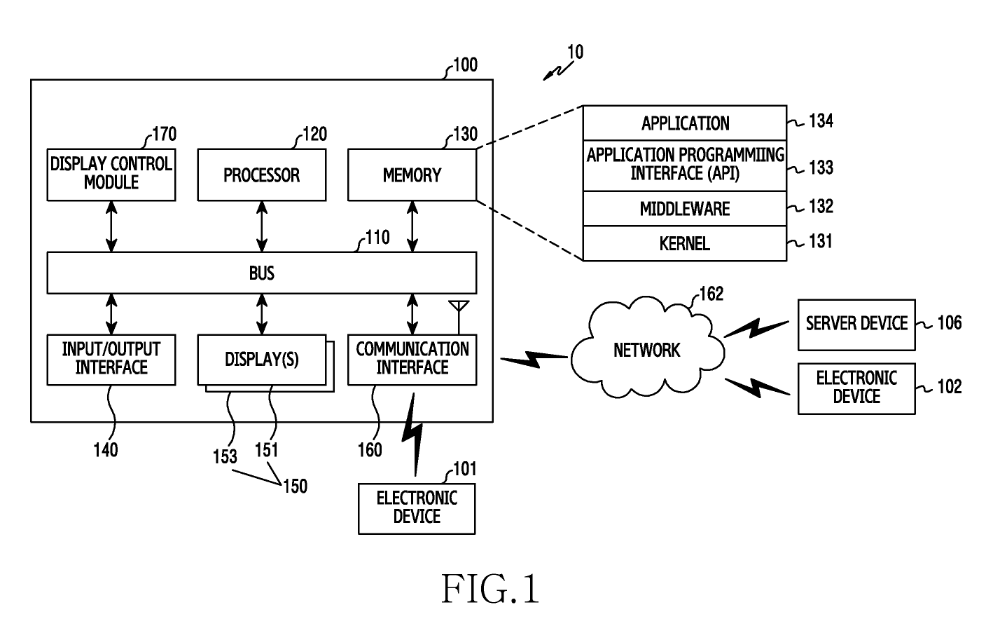

FIG. 1 is a diagram illustrating an electronic device use environment according to various example embodiments of the present disclosure.

Referring to FIG. 1, the electronic device use environment 10 may include an electronic device 100, external electronic devices 101 and 102, a server device 106, and a network 162.

The electronic device use environment 10 may provide a plurality of displays 150 to the electronic device 100, and support to make the movement of objects more intuitive and easy on at least one of the plurality of displays 150. The external electronic devices 101 and 102 may provide at least one object or object related information to the electronic device 100.

The object may be at least one of an image, an icon, a file, or a text that are displayed on the display 150. For instance, the object may include a widget, an icon (e.g., a web running icon, a file icon, and a folder icon), a menu item, link information, and a photo that are displayed on the display 150.

The object related information may include execution data executed in response to a selection of the object displayed on the display 150, or program data related to execution. For instance, the object related information may include file information executed according to a selection of a file icon, or corresponding program data executed according to a selection of a menu item and program execution data, or a browser executed according to a selection of link information and execution data provided according to the execution of a link function.

The electronic device use environment 10 may form a communication channel between the external electronic device 101, 102 and the electronic device 100, and transmit or copy at least one of at least one object or object related information to the external electronic device 101, 102 in a process of moving at least one object, which is stored in the electronic device 100, between the plurality of displays 150.

The electronic device 101 may form a communication channel with a communication interface 160 of the electronic device 100. For instance, the electronic device 101 may form a short-range communication channel or wired communication channel with the communication interface 160. The electronic device 101 may form a Bluetooth communication channel or a Wi-Fi direct communication channel with the communication interface 160.

In response to the occurrence of an event (e.g., a touch event, or an event based on an input/output interface 140) occurring in the electronic device 100, the electronic device 101 may receive at least one object, which is arranged on the display 150 of the electronic device 100, from the electronic device 100 through a communication channel. In response to the event occurring in the electronic device 100, the electronic device 101 may transmit at least one part of a screen, which is being outputted to the electronic device 101, to the electronic device 100.

The electronic device 101 may be also prepared in a wearable type. The electronic device 102 may form a communication channel with the electronic device 100 through the network 162. For instance, the electronic device 102 may include a cellular communication module, and form a mobile communication channel with the electronic device 100. Or, the electronic device 102 may include a Wi-Fi communication module, and form a mobile communication channel with the electronic device 100.

The electronic device 102 may use the formed communication channel to transmit/receive at least one object and object related information with the electronic device 100. For instance, the electronic device 102 may receive at least one object displayed on the first display 151 of the electronic device 100 and object related information or at least one object displayed on the second display 153 of the electronic device 100 and object related information, from the electronic device 100 through the communication channel.

The electronic device 102 may receive a message or electronic mail (e-mail) transmitted by the electronic device 100, or may transmit/receive a chatting message with the electronic device 100. The network 162 may form a communication channel between the electronic device 100 and the electronic device 102. For instance, the network 162 may include network device elements related to mobile communication channel forming. Or, the network 162 may include network device elements related to Internet communication channel forming.

In response to a request of the electronic device 100, the network 162 may forward at least one of a specific object and object related information to the electronic device 102. The server device 106 may form a communication channel with the electronic device 100 through the network 162. The server device 106 may provide the electronic device 100 with at least one of an object and object related information to be outputted to the display 151 of the electronic device 100 or an object and object related information to be outputted to at least one display 153.

The server device 106 may also support forming and using of a chatting channel of the electronic device 100. The electronic device 100 may include the plurality of displays 151 and 153, and support at least one of moving, copying, or removing of an object between the displays 151 and 153. In response to a user input, the electronic device 100 may move or copy an object, which is displayed on a specific display, to another display.

The electronic device 100 may support screen replacement in association with object move. In response to an event occurring in a specific display, the electronic device 100 may output a specific function execution screen to another display.

Referring to FIG. 1, the electronic device 100 may include a bus 110, a processor 120, a memory 130, the input/output interface 140, the display 150, the communication interface 160, and a display control module 170. Additionally or alternatively, the electronic device 100 may further include a sensor module, and at least one camera module.

The bus 110 may be a circuit connecting the aforementioned constituent elements with one another and forwarding communication (e.g., a control message) between the aforementioned constituent elements. For instance, the bus 110 may forward an input signal inputted from the input/output interface 140, to at least one of the processor 120 or the display control module 170.

The bus 110 may forward at least one part of an object or object related information, which are received through the communication interface 160, to at least one of the processor 120, the memory 130, the display 150, or the display control module 170. In response to control of the display control module 170, the bus 110 may forward an object, which is stored in the memory 130, to the display 150.

The processor 120 may, for example, receive instructions from the aforementioned other constituent elements (e.g., the memory 130, the input/output interface 140, the display 150, the communication interface 160, or the display control module 170) through the bus 110, and decipher the received instructions, and execute operation or data processing according to the deciphered instructions.

The processor 120 may be prepared in a form of including the display control module 170 or in a form of being independent from the display control module 170, and may be prepared in a form of performing communication directly or based on the bus 110.

The memory 130 may store an instruction or data, which is received from the processor 120 or the other constituent elements (e.g., the input/output interface 140, the display 150, the communication interface 160, or the display control module 170) or is generated by the processor 120 or the other constituent elements.

The memory 130 may include, for example, programming modules such as a kernel 131, a middleware 132, an Application Programming Interface (API) 133, or an application 134. The aforementioned programming modules each may include software, firmware, hardware or a combination of at least two or more of them.

The kernel 131 may control or manage system resources (e.g., the bus 110, the processor 120, or the memory 130) used to execute operations or functions implemented in the remnant other programming modules, for example, the middleware 132, the API 133, or the application 134. Also, the kernel 131 may provide an interface enabling the middleware 132, the API 133, or the application 134 to access and control or manage the individual constituent element of the electronic device 100.

The middleware 132 may perform a relay role of enabling the API 133 or the application 134 to communicate with the kernel 131 and exchange data with the kernel 131. Also, in association with work requests received from the application 134, the middleware 132 may, for example, perform control (e.g., scheduling or load balancing) for the work requests by using a method of allocating priority order capable of using the system resources (e.g., the bus 110, the processor 120, or the memory 130) of the electronic device 100 to at least one of the applications 134.

The API 133, which is an interface enabling the application 134 to control a function provided by the kernel 131 or the middleware 132, may include, for example, at least one interface or function (e.g., instruction) for file control, window control, picture processing, or character control.

The application 134 may include a Short Message Service/Multimedia Message Service (SMS/MMS) application, an electronic mail (e-mail) application, a calendar application, an alarm application, a health care application (e.g., an application measuring momentum or blood sugar), or environment information application (e.g., an application providing air pressure, humidity, or temperature information). Additionally or alternatively, the application 134 may be an application related to information exchange between the electronic device 100 and the external electronic device (e.g., the electronic device 101, 102).

The memory 130 may store at least one object and object related information. The at least one object may include at least one object displayed on the display 150. For instance, the object may be at least one of a file, an item, a widget, or an icon.

The object may be an image (or at least one of the image or a text) displayed on the display 150. The object related information, which is data related to the object, may include program data and program execution data.

For example, a photo related function may include an object corresponding to a thumbnail image displayed on the display 150 in association with a photo file, and object related information corresponding to the photo file. A chatting function may include object related information corresponding to chatting related program data, and an object corresponding to a chatting icon that is displayed on the display 150 in response to a chatting related program.

Also, a folder function may include object related information corresponding to folder data, and an object corresponding to an icon indicating a folder. A weather notification function may include object related information corresponding to a browser that is set up to connect to a server device providing weather information, and an object corresponding to an icon related to the execution of the browser.

The input/output interface 140 may forward an instruction or data, which is inputted from a user through an input/output device (e.g., a sensor, a keyboard, or a touch screen), for example, to the processor 120, the memory 130, the communication interface 160, or the display control module 170 through the bus 110. For example, the input/output interface 140 may provide data about a user's touch inputted through the touch screen, to the processor 120.

The input/output interface 140 may, for example, output an instruction or data, which is received from the processor 120, the memory 130, the communication interface 160, or the display control module 170 through the bus 110, through the input/output device (e.g., a speaker or a display).

The input/output interface 140 may include a physical key button (e.g., a home key, a side key, and a power key), a jog key, and a key pad. The input/output interface 140 may include a virtual key pad outputted to the display 150, as an input device.

The input/output interface 140 may perform a function related to audio processing. In association with this, the input/output interface 140 may include at least one of a speaker or a microphone single or in plural. Under the control of the display control module 170, the input/output interface 140 may, for example, output audio data included in Application (App) execution data to be outputted to the display 150, through the speaker.

The input/output interface 140 may output at least one audio data included in App execution data to be outputted to the plurality of the displays 150. The aforementioned audio data output of the input/output interface 140 may be also omitted depending on user's setup or electronic device 100's support or non-support.

The display 150 may display various kinds of information (e.g., multimedia data or text data). For instance, the display 150 may output a lock screen and a waiting screen. In response to function execution, the display 150 may output a specific function execution screen, for instance, a sound source playback App execution screen, a video playback App execution screen, and a broadcast reception screen.

The display 150 may output at least one App related screen or App execution screen executed in the electronic device 100. The App related screen or App execution screen, which is a screen related to App execution, may be at least one (hereinafter, referred to as an “App execution screen”) of an execution screen of an App that is currently running, a capture screen captured during App execution record, screens to be displayed on a display at App execution, or a screen applying input processing during App execution.

The display 150 may be arranged in series (or at certain intervals) in plural, and be operated according to control of one display control module 170 or a plurality of display control modules. The plurality of displays 151 and 153 may output at least one of a plurality of App execution screens.

In response to an input event, an object outputted to a display may be move-displayed on another display (i.e., the object disappears from the current display and is displayed on another display) or be copy-displayed on another display (i.e., the object is displayed on both the current display and another display).

The communication interface 160 may establish communication between the electronic device 100 and the external device (e.g., the electronic device 101, 102 or the server device 106). For example, the communication interface 160 may connect to a network 162 through wireless communication or wired communication, to communicate with the external device.

The wireless communication may include, for example, at least one of Wireless Fidelity (Wi-Fi), Bluetooth (BT), Near Field Communication (NFC), Global Positioning System (GPS), or cellular communication (e.g., Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM)).

The wired communication may include, for example at least one of a Universal Serial Bus (USB), a High Definition Multimedia Interface (HDMI), a Recommended Standard-232 (RS-232), or a Plain Old Telephone Service (POTS).

The network 162 may be a telecommunications network. The telecommunications network may include at least one of a computer network, the Internet, the Internet of things, or a telephone network. A protocol (e.g., a transport layer protocol, a data link layer protocol, or a physical layer protocol) for communication between the electronic device 100 and the external device may be supported in at least one of the application 134, the application programming interface 133, the middleware 132, the kernel 131, or the communication interface 160.

In case that the electronic device 100 supports a plurality of communication schemes, the communication interface 160 may include a plurality of communication modules. For instance, the electronic device 100 may include a communication module, for instance, a short-range communication module or a direct communication module, which may form a communication channel directly with the electronic device 101.

The short-range communication module or direct communication module may include at least one of various communication modules such as a Wi-Fi direct communication module, a BT communication module, or a Zigbee communication module. Also, the direct communication module may include a wired communication module such as a cable.

The communication interface 160 may receive object related information from at least one of the electronic device 102 or the server device 106. The communication interface 160 may forward the received object related information to the display control module 170. The display control module 170 may store the received object related information in the memory 130.

Among the object related information stored in the memory 130, an object image may be outputted to the display 150. If an object image selection event takes place, a corresponding object image may be move-displayed. Or, object data (e.g., an App execution screen) corresponding to object image selection may be outputted.

The display control module 170 may process at least one part of information acquired from the other constituent elements (e.g., the processor 120, the memory 130, the input/output interface 140, or the communication interface 160), and provide the processed information to a user in various methods. For example, the display control module 170 may control to output at least one object to at least one of the plurality of displays 151 and 153.

In response to an event of selecting at least one object, the display control module 170 may select a specific object. And, in response to an addition event, the display control module 170 may process a function related to the selected object based on another display.

In response to schedule information or in response to user input control, the display control module 170 may control to display at least one object on the display 151. Based on input event occurrence, the display control module 170 may perform object function processing related to the display 153.

The related function processing may include at least one of function processing of move-displaying or copy-displaying an object on the display 153, function processing of executing a specific App related to the object and outputting an App execution screen to the display 153, and function processing providing the object as input information of at least one App.

In association with input information processing, in accordance with the kind of an App, the display control module 170 may process an object into an attachment file of a corresponding App, or process the object into file uploading related to a file transmission function of the corresponding App, or process the object into an editing state related to a file editing function of the corresponding App.

The display control module 170 may process an object into a phone number related to a phone call function, or process the object into address information related to a webpage access function. The display control module 170 may control designated function processing, which exploits the object as input information, based on an attribute of the object or object information.

The display control module 170 may receive a first input event from an input device arranged in the display 151 (e.g., at least one of a touch screen, a touch sheet, or a physical key arranged in the display 151), and may select at least one object displayed on the display 151, in response to the first input event.

In response to reception of a second input event, the display control module 170 may process the selected object into input information to be forwarded to at least one second display 153. Herein, the second input event may include an input event occurring in at least one of an input device related to the display 151 or an input device related to the display 153.

The first input event may include at least one of a touch event of touching an object displayed on the display 151 with a hand or touching the object with an electronic pen or a hovering event of indicating the displayed object.

The second input event may include at least one of a touch event of touching at least one point on the display 151, a touch event of taking a motion after touching, a touch event of touching and holding during a designated time, a touch event of touching repeatedly or in many times at designated time intervals, a hovering event of indicating at least one point on the display 151, a hovering event of taking a motion after indicating, a hovering event of indicating and holding during a designated time, and a hovering event of indicating repeatedly or in many times at designated time intervals.

According to an example embodiment of the present disclosure, visual information (or display information) related to at least one display 153 may be overlaid on the display 151. The visual information may include at least one part of data displayed on an App execution screen. If an object is overlaid on the visual information, the display control module 170 may control to display a corresponding object on the display 151 correspondingly to a position of the object overlaid on the visual information.

In response to an input event or in response to at least one of a movement position of the object, a position after movement thereof, or an arranged position thereof, the display control module 170 may control to display on the display 153 a virtual object related to an object selected in the display 151. If a virtual object related input event takes place, in response to the input event, the display control module 170 may control to move or copy to the display 153 an object displayed on the display 151.

The virtual object may be at least one App execution screen related to the display 153. In response to an input event occurring on the display 153, the display control module 170 may change the displaying of the App execution screen on the display 153. The display control module 170 may control to concurrently display at least some of a plurality of App execution screens. For instance, the display control module 170 may arrange for some of the respective App execution screens to be overlapped with one another and arrange for others to be unhidden.

If an object is selected on the display 151, the display control module 170 may control to output to the display 153 an execution screen of an App related to the selected object. Herein, the display control module 170 may control to change at least one part of the execution screen of the object related App and output the changed execution screen to the display 153. For instance, the App execution screen outputted to the display 151 in association with the object and the App execution screen outputted to the display 153 may include at least one part of different data.

The display control module 170 may also control to output the same App execution screen to the display 151 or the display 153. According to an example embodiment of the present disclosure, the display control module 170 may control to output App related information (e.g., an icon and a menu item), which is executable in association with an object outputted to the display 151, to at least one of the display 151 or the display 153.

The display control module 170 may process at least one App related information related to a selected object among App related information outputted to at least one of the display 151 or the display 153, into an activation state (e.g., a selection and execution possible state, and image maintaining or changing).

The display control module 170 may process at least one App related information having no relation with a selected object, into an inactivation state (e.g., selection or execution impossibility, and image changing). If at least one of the App related information of the activation state is selected, the display control module 170 may control to execute a corresponding App, and output an App execution screen to at least one of the display 151 or the display 153.

The display control module 170 may control to output App related information related to an object selected on the display 151, to the display 153, and output an App execution screen corresponding to App related information selected on the display 153, to the display 151. In this operation, the display control module 170 may control to maintain the selected object on the display 151.

The display control module 170 may control to process a selected object into input information of an App corresponding to an App execution screen outputted to the display 151. Or, in response to event occurrence, the display control module 170 may control to execute at least one App related to an object, or display an App execution screen on the display 153 but display the selected object on the App execution screen of the display 153.

In response to event occurrence, the display control module 170 may change an object displayed moving from the display 151 to the display 153. For example, in response to the occurrence of an event (i.e., at least one of a touch event or hovering event occurring in association with the display 151), the display control module 170 may magnify or reduce a size of the object displayed on the display 153.

In response to reception of a first input event, the display control module 170 may display visual information related to at least one object displayed on the display 151, on the display 153. In response to reception of a second input event, the display control module 170 may process a specific object displayed on the display 153 into input information of the display 151. For instance, in case that moving an object from visual information overlaying the object to the outside of a range of the visual information, the display control module 170 may control to arrange the corresponding object in a displayed display.

The display control module 170 may control to output a first App execution screen to the display 151, and output a second App execution screen to the display 153. In response to input event occurrence or in response to at least one of relative positions of the display 151 and the display 153 or a bending angle or bending direction of at least one of the display 151 or the display 153, the display control module 170 may control screen switching. For instance, in case that at least one of the display 151 or the display 153 is hinge-operated according to at least one of a designated direction or designated angle, the display control module 170 may mutually share and convert at least one part of an App execution screen outputted to the display 151 or the display 153.

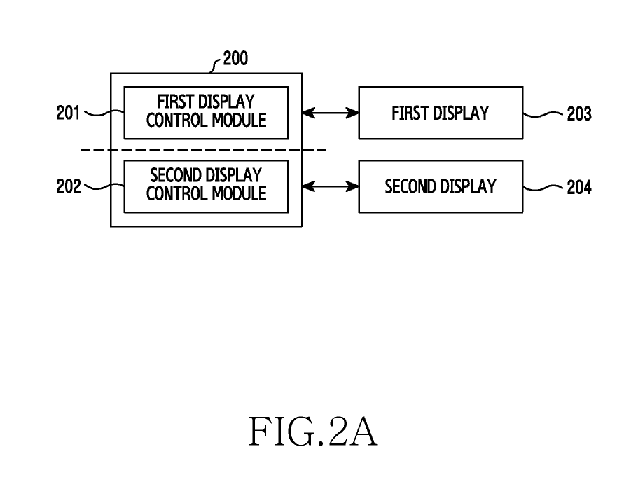

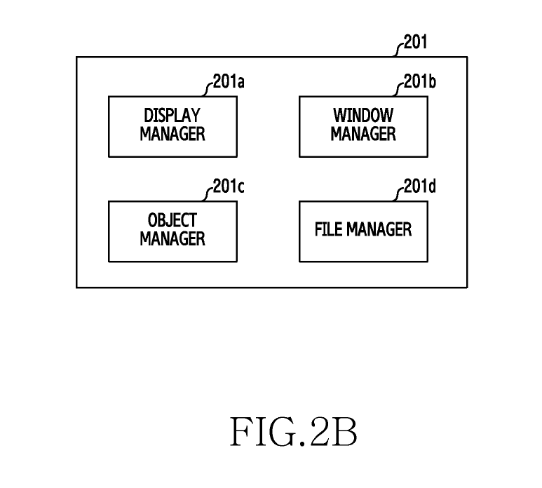

FIG. 2A and FIG. 2B are diagrams illustrating a display control module and a display according to various example embodiments of the present disclosure.

Referring to FIG. 2A, the display control module 200 may include at least one of a first display control module 201 interworking with a first display 203, and a second display control module 202 interworking with a second display 204.

Referring to FIG. 2B, any one of the display control modules, for example, the first display control module 201 may include a display manager 201a, a window manager 201b, an object manager 201c, and a file manager 201d. The managers, constituent elements capable of being implemented in software or firmware, may be also implemented as one constituent element. A name of each manager is an operative expression according to a management operation.

The display manager 201a may manage the first display 203. The window manager 201b may manage a window displayed on the first display 203. The object manager 201c may manage an object displayed on the first display 203. The file manager 201d may manage files displayed on the first display 203.

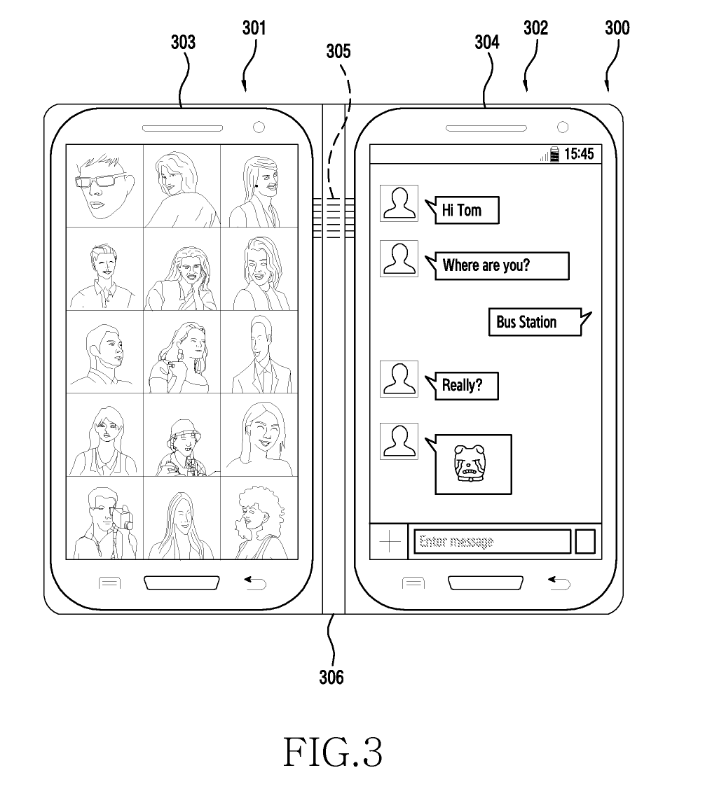

FIG. 3 is a diagram illustrating an appearance of an electronic device according to various example embodiments of the present disclosure.

Referring to FIG. 3, the electronic device 300 may include a first display device 301, a second display device 302, a signal line 305, and a hinge part 306. The hinge part 306 is rotatable at certain angles. For instance, the electronic device 300 may support for the second display device 302 to be rotatable at 360 degrees with respect to the first display device 301.

The signal line 305 may operatively connect the first display device 301 and the second display device 302 with each other, and forward a control signal or contents information of a first display control module arranged in the first display device 301, to the second display device 302. For instance, the signal line 305 may be prepared in a Flexible Printed Circuit Board (FPCB) type.

The first display device 301 may include a first display 303 and the first display control module. The second display device 302 may include a second display 304 and a second display control module. According to various example embodiments, the first display device 301 or the second display device 302 may share and manage one display control module.

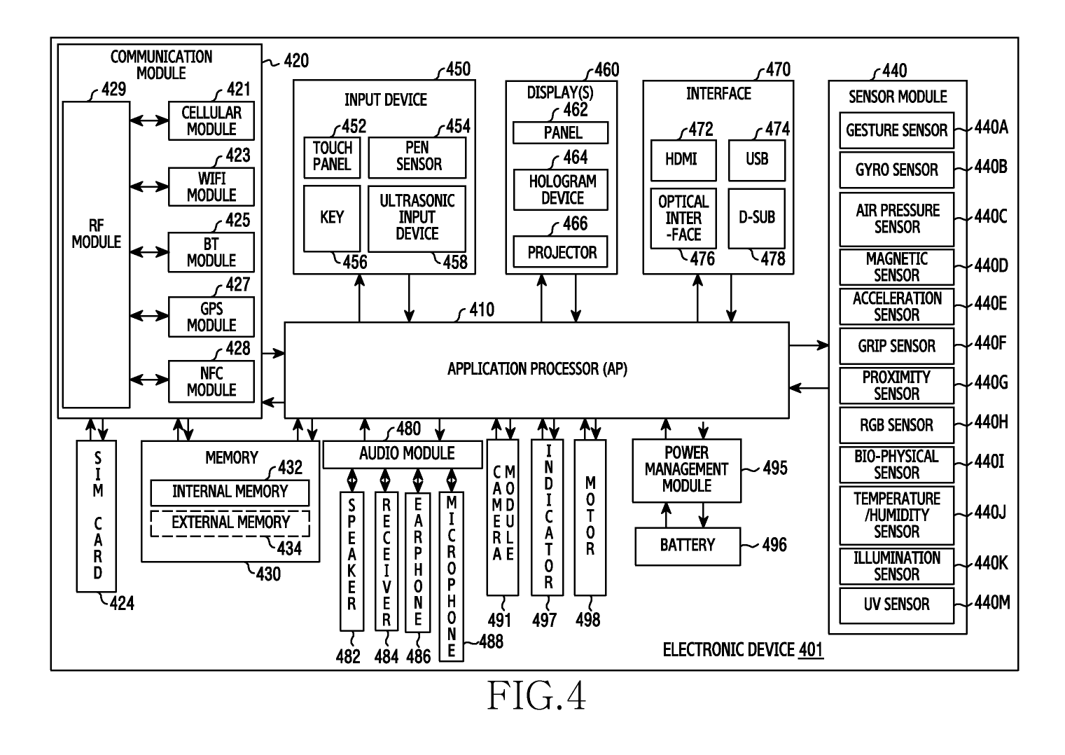

FIG. 4 is a block diagram illustrating hardware of an electronic device according to various example embodiments of the present disclosure. The electronic device 401 may implement, for example, the whole or one part of the electronic device 100 illustrated in FIG. 1.

Referring to FIG. 4, the electronic device 401 may include one or more Application Processors (APs) 410 (e.g., the processor 120 and the display control module 170), a communication module 420 (e.g., the communication interface 160), a Subscriber Identification Module (SIM) card 424, a memory 430 (e.g., the memory 130), a sensor module 440, an input device 450 (e.g., an input/output interface 140), a display 460 (e.g., displays 150, 151, and 153), an interface 470, an audio module 480 (e.g., the input/output interface 140), a camera module 491, a power management module 495, a battery 496, an indicator 497, and a motor 498.

The AP 410 may run an operating system or an application program to control a plurality of hardware or software constituent elements connected to the AP 410, and may perform processing and operation of various data including multimedia data. The AP 410 may be, for example, implemented as a System On Chip (SoC).

According to one example embodiment, the AP 410 may further include a Graphic Processing Unit (GPU) (not shown). The AP 410 may support a function of the display control module 170. In response to event occurrence, the AP 410 may control to move-display or copy-display an object outputted to a specific display, to another display. In response to event occurrence, the AP 410 may support the execution of various functions related to an object.

The communication module 420 (e.g., the communication interface 160) may perform data transmission/reception in communication between the electronic device 401 (e.g., the electronic device 100) and other electronic devices (e.g., the electronic devices 101 and 102 or the server device 106) connected through the network 162. According to one example embodiment, the communication module 420 may include a cellular module 421, a Wi-Fi module 423, a BT module 425, a GPS module 427, an NFC module 428, and a Radio Frequency (RF) module 429.

The cellular module 421 may provide voice telephony, video telephony, a text service, or an Internet service through a telecommunication network (e.g., LTE, LTE-A, CDMA, WCDMA, UMTS, WiBro, or GSM). Also, the cellular module 421 may, for example, use a subscriber identification module (e.g., the SIM card 424) to perform electronic device distinction and authorization within the telecommunication network. According to one example embodiment, the cellular module 421 may perform at least some functions among functions that the AP 410 may provide. For example, the cellular module 421 may perform at least one part of a multimedia control function.

According to one example embodiment, the cellular module 421 may include a Communication Processor (CP). Also, the cellular module 421 may be, for example, implemented as a SoC. In FIG. 4, the constituent elements such as the cellular module 421 (e.g., the communication processor), the memory 430, or the power management module 495 are illustrated as constituent elements different from the AP 410 but, according to one example embodiment, the AP 410 may be implemented to include at least some (e.g., the cellular module 421) of the aforementioned constituent elements.

According to one example embodiment, the AP 410 or the cellular module 421 (e.g., the communication processor) may load an instruction or data, which is received from a non-volatile memory connected to each or at least one of other constituent elements, to a volatile memory or process the loaded instruction or data. Also, the AP 410 or the cellular module 421 may store data, which is received from at least one of other constituent elements or is generated by at least one of the other constituent elements, in the non-volatile memory.

The Wi-Fi module 423, the BT module 425, the GPS module 427 or the NFC module 428 each may include, for example, a processor for processing data transmitted/received through the corresponding module. In FIG. 4, the cellular module 421, the Wi-Fi module 423, the BT module 425, the GPS module 427 or the NFC module 428 is each illustrated as a separate block but, according to one example embodiment, at least some (e.g., two or more) of the cellular module 421, the Wi-Fi module 423, the BT module 425, the GPS module 427 or the NFC module 428 may be included within one IC or IC package. For example, at least some (e.g., the communication processor corresponding to the cellular module 421 and a Wi-Fi processor corresponding to the Wi-Fi module 423) of the processors each corresponding to the cellular module 421, the Wi-Fi module 423, the BT module 425, the GPS module 427 or the NFC module 428 may be implemented as one SoC.

The RF module 429 may perform transmission/reception of data, for example, transmission/reception of an RF signal. Though not illustrated, the RF module 429 may include, for example, a transceiver, a Power Amplifier Module (PAM), a frequency filter, or a Low Noise Amplifier (LNA). Also, the RF module 429 may further include a component for transmitting/receiving an electromagnetic wave in a free space for wireless communication, for example, a conductor or a conductive wire.

FIG. 4 illustrates that the cellular module 421, the Wi-Fi module 423, the BT module 425, the GPS module 427 and the NFC module 428 share one RF module 429 with one another but, according to one example embodiment, at least one of the cellular module 421, the Wi-Fi module 423, the BT module 425, the GPS module 427 or the NFC module 428 may perform transmission/reception of an RF signal through a separate RF module.

The SIM card 424 may be a card including a subscriber identification module, and may be inserted into a slot provided in a specific position of the electronic device 401. The SIM card 424 may include unique identification information (e.g., an Integrated Circuit Card ID (ICCID)) or subscriber information (e.g., an International Mobile Subscriber Identity (IMSI)).

The memory 430 (e.g., the memory 130) may include an internal memory 432 or an external memory 434. The internal memory 432 may include, for example, at least one of a volatile memory (for example, a Dynamic Random Access Memory (DRAM), a Static RAM (SRAM) and a Synchronous Dynamic RAM (SDRAM)) or a non-volatile memory (for example, a One-Time Programmable Read Only Memory (OTPROM), a Programmable ROM (PROM), an Erasable and Programmable ROM (EPROM), an Electrically Erasable or Programmable ROM (EEPROM), a mask ROM, a flash ROM, a Not AND (NAND) flash memory, and a Not OR (NOR) flash memory).

According to one example embodiment, the internal memory 432 may be a Solid State Drive (SSD). The external memory 434 may further include a flash drive, for example, Compact Flash (CF), Secure Digital (SD), micro-SD, mini-SD, extreme Digital (xD), or a memory stick. The external memory 434 may be operatively connected with the electronic device 401 through various interfaces. According to one example embodiment, the electronic device 401 may further include a storage device (or a storage media) such as a hard drive.

The sensor module 440 may measure a physical quantity or sense an activation state of the electronic device 401, to convert measured or sensed information into an electric signal. The sensor module 440 may include, for example, at least one of a gesture sensor 440A, a gyro sensor 440B, an air pressure sensor 440C, a magnetic sensor 440D, an acceleration sensor 440E, a grip sensor 440F, a proximity sensor 440G, a color sensor 440H (e.g., a Red, Green, Blue (RGB) sensor), a bio-physical sensor 440I, a temperature/humidity sensor 440J, an illumination sensor 440K, or a Ultraviolet (UV) sensor 440M.

Additionally or alternatively, the sensor module 440 may include, for example, an E-nose sensor (not shown), an Electromyography (EMG) sensor (not shown), an Electroencephalogram (EEG) sensor (not shown), an Electrocardiogram (ECG) sensor (not shown), an Infrared (IR) sensor (not shown), an iris sensor (not shown), or a fingerprint sensor (not shown). The sensor module 440 may further include a control circuit for controlling at least one or more sensors belonging therein.

The input device 450 may include a touch panel 452, a (digital) pen sensor 454, a key 456, or an ultrasonic input device 458. The touch panel 452 may, for example, detect a touch input in at least one of a capacitive overlay scheme, a pressure sensitive scheme, an infrared beam scheme, or an acoustic wave scheme.

Also, the touch panel 452 may also further include a control circuit. In a case of the capacitive overlay scheme, physical contact or proximity detection is possible. The touch panel 452 may also further include a tactile layer. In this case, the touch panel 452 may provide a tactile response to a user.

The (digital) pen sensor 454 may be implemented in the same or similar method to receiving a user's touch input or by using a separate sheet for detection. The key 456 may include, for example, a physical button, an optical key, or a keypad. The ultrasonic input device 458 is a device capable of identifying data by sensing a sound wave with a microphone (e.g., the microphone 488) in the electronic device 401 through an input tool generating an ultrasonic signal, and enables wireless detection. According to one example embodiment, the electronic device 401 may also use the communication module 420 to receive a user input from an external device (e.g., a computer or a server) connected with this.

The display 460 (e.g., the display 150) may include a panel 462, a hologram device 464, or a projector 466. The panel 462 may, for example, be a Liquid Crystal Display (LCD) or an Active-Matrix Organic Light-Emitting Diode (AMOLED). The panel 462 may be implemented to be flexible, transparent, or wearable.

The panel 462 may be prepared in plural. In case that a plurality of panels 462 are prepared, the panels 462 may be arranged in parallel. The plurality of panels 462 arranged in parallel may be folded by a hinge operation or may be arranged at specific angles with respect to one another.

In response to event occurrence, at least one object may be outputted to at least one of the plurality of panels 462. The outputted object may be selected in response to event occurrence, and may be used as input information of another panel in response to addition event occurrence.

The panel 462 may be also implemented as one module along with the touch panel 452. The hologram device 464 may show a three-dimensional image in the air by using interference of light. The projector 466 may project light to a screen to display an image. The screen may be, for example, located inside or outside the electronic device 401. According to one example embodiment, the display 460 may further include a control circuit for controlling the panel 462, the hologram device 464, or the projector 466.

The interface 470 may include, for example, a HDMI 472, a USB 474, an optical interface 476, or a D-subminiature (D-sub) 478. The interface 470 may be included, for example, in the communication interface 160 shown in FIG. 1. Additionally or alternatively, the interface 470 may include, for example, a Mobile High-definition Link (MHL) interface, a Secure Digital (SD) card/Multi Media Card (MMC) interface or an Infrared Data Association (IrDA) standard interface.

The audio module 480 may convert a voice and an electric signal interactively. At least some constituent elements of the audio module 480 may be included, for example, in the input/output interface 140 illustrated in FIG. 1. The audio module 480 may, for example, process sound information which is inputted or outputted through a speaker 482, a receiver 484, an earphone 486, or the microphone 488.

The camera module 491 is a device able to take a still picture and a moving picture. According to one example embodiment, the camera module 491 may include one or more image sensors (e.g., a front sensor or a rear sensor), a lens (not shown), an Image Signal Processor (ISP) (not shown), or a flash (not shown) (e.g., a Light Emitting Diode (LED) or a xenon lamp).

The power management module 495 may manage electric power of the electronic device 401. Though not illustrated, the power management module 495 may include, for example, a Power Management Integrated Circuit (PMIC), a charger IC, or a battery or fuel gauge.

The PMIC may be, for example, mounted within an integrated circuit or a SoC semiconductor. A charging scheme may be divided into a wired charging scheme and a wireless charging scheme. The charger IC may charge the battery 496, and may prevent the inflow of overvoltage or overcurrent from an electric charger. According to one example embodiment, the charger IC may include a charger IC for at least one of the wired charging scheme or the wireless charging scheme. The wireless charging scheme may, for example, be a magnetic resonance scheme, a magnetic induction scheme, or an electromagnetic wave scheme. A supplementary circuit for wireless charging, for example, a circuit such as a coil loop, a resonance circuit, or a rectifier may be added.

The battery gauge may, for example, measure a level of the battery 496, a voltage during charging, a current or a temperature. The battery 496 may generate or store electricity, and use the stored or generated electricity to supply power to the electronic device 401. The battery 496 may include, for example, a rechargeable battery or a solar battery.

The indicator 497 may display a specific status of the electronic device 401 or one part (e.g., the AP 410) thereof, for example a booting state, a message state, or a charging state.

The motor 498 may convert an electric signal into a mechanical vibration. Though not illustrated, the electronic device 401 may include a processing device (e.g., a GPU) for mobile TV support. The processing device for mobile TV support may, for example, process media data according to the standards of Digital Multimedia Broadcasting (DMB), Digital Video Broadcasting (DVB), or a media flow.

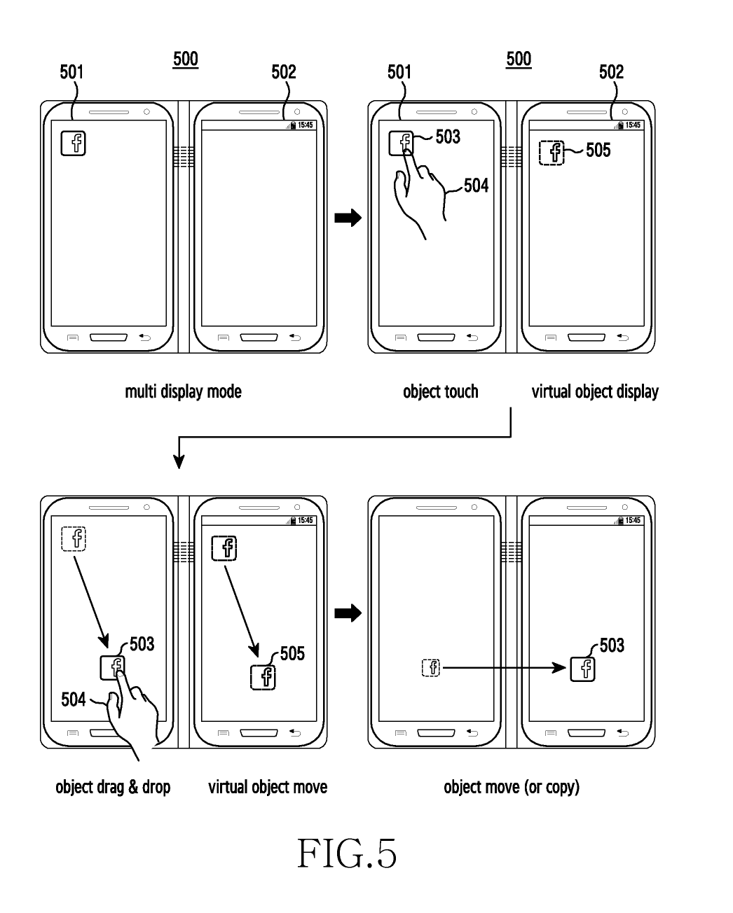

FIG. 5 is a diagram illustrating a multi display control method of an electronic device according to various example embodiments of the present disclosure.

Referring to FIG. 5, the electronic device 500 may be, for example, various types of electronic devices such as a smartphone or a tablet PC. The electronic device 500 may include a first display 501 and a second display 502, which are physically separated but operatively interwork with each other. The first display 501 may be a main display, and the second display 502 may be a sub display. Or, inversely, the second display 502 may be a main display, and the first display 501 may be a sub display.

The main display and the sub display may be changed by user's selection. Also, for example, arbitrary one display in which a user's touch initially takes place while the electronic device 500 performs a multi display operation may be a main display, and the other display may be a sub display. Other various methods may be applied.

In a state in which arbitrary one object 503 is displayed on the first display 501, in cases where a user 504 touches the object 503 displayed on the first display 501 with a finger or electronic pen, or holds a hovering or touch state more than a certain time, or in case that the user 504 performs a predefined object selection operation, for example, by using a menu to select the object 503, the display control module 170 described earlier with reference to FIG. 1 may determine that the object 503 has been selected by the user's touch or the predefined selection operation.

The display control module 170 may, for example, control all of a plurality of displays, or control one display. The display control module 170, which is an implementation separate from the processor 120 described earlier with reference to FIG. 1, may, for example, interwork with the processor 120 or may be variously included in software or firmware within the processor 120. Below, a detailed description is made for an example embodiment in which the display control module 170 is included in the processor 120.

The processor 120 may create a virtual object 505 corresponding to the object 503 selected (e.g., touched) by the user 504, and display the virtual object 505 on the second display 502. The virtual object 505 may be displayed in a specific position of the second display 502 corresponding to a position of the first display 501 in which the object 503 is displayed, and may be displayed in a shape the same or similar to the object 503, or may be displayed variously in a specific shape, color, and brightness different from the object 503.

In case that the object 503 displayed on the first display 501 is selected by a user and then is dragged to an arbitrary position of the first display 501, the processor 120 may perform an operation interworking with the drag operation, to move the virtual object 505 displayed on the second display 502, to a corresponding position of the second display 502.

Thereafter, in case that the user 504 performs an operation of releasing (e.g., dropping) the selection of the dragged object 503, the processor 120 may perform an operation of moving, copying or inserting the object 503 to the position of the virtual object 505 moved to the corresponding position of the second display 502.

For example, in a state in which a plurality of photo images are displayed in a list form on the first display 501 and an arbitrary document writing screen is displayed on the second display 502, if a user performs a drag and drop operation after touching a specific image on the first display 501, the processor 120 may perform an operation of moving, copying or inserting the specific image to the document writing screen of the second display 502.

The selection of the object is possible even by a touch or hover input utilizing an electronic pen. In a case of the hovering, a drop operation may be also performed by, for example, pressing a button of the electronic pen.

Also, in a situation in which a first application is running on the first display and a second application is running on the second application, a user may select one (e.g., an object) of constituent elements of the first application and thereafter, move the selected object to the second application through a drag and drop operation. Inversely, even the moving of the object from the second application to the first application is possible using this same method.

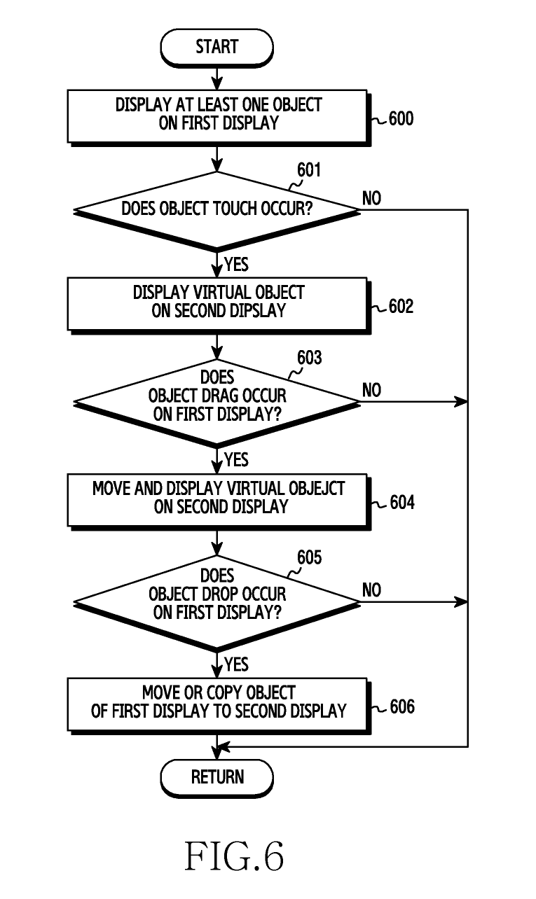

FIG. 6 is a flowchart illustrating an operation of a multi display control method according to various example embodiments of the present disclosure.

Referring to FIG. 6, in operation 600, the processor 120 may display at least one object on a first display. In operation 601, the processor 120 may sense (e.g., detect and/or identify) whether the object displayed on the first display is “touched” or “hovered over” by detecting the corresponding input generated by interaction of a user's finger or an electronic pen the a touch screen, to determine the occurrence or non-occurrence of the object touch.

If the determination result is that the object touch occurs, in operation 602, the processor 120 may display a virtual object on a second display. In operation 603, the processor 120 may sense whether the object touched in the first display is dragged to an arbitrary position of the first display, to determine the occurrence or non-occurrence of the object drag. The object selection may be performed by a touch or hovering, or may also utilize an operation involving menu selection after the touch input.

If the determination result is that the object drag occurs, in operation 604, the processor 120 may interwork utilizing the drag to move the virtual object displayed on the second display to a corresponding position of the second display. Thereafter, in operation 605, the processor 120 may sense if the object dragged on the first display is dropped, to determine the occurrence or non-occurrence of the object drop.

If the determination result is that the object drop occurs, in operation 606, the processor 120 may perform an operation of moving and/or copying the object to the position of the second display in which the virtual object is displayed.

In accordance with this description, the user may move or copy the object to an arbitrary position of the second display through the operation of touching, dragging and dropping the object on the first display.

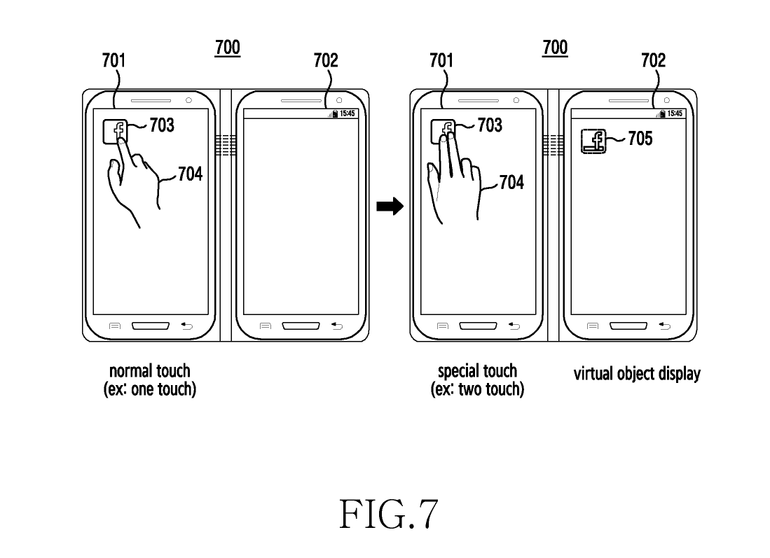

FIG. 7 is a diagram illustrating a virtual object display method according to various example embodiments of the present disclosure.

Referring to FIG. 7, the electronic device 700 may include a first display 701 and a second display 702, which are physically separate but operatively interworking with one another. Any one of the first display 701 and the second display 702 may be set up as a main display, and the other may be set up as a sub display.

The first display 701 and the second display 702 may be controlled by the display control module 170 described earlier with reference to FIG. 1. The display control module 170 may, for example, interwork with the processor 120, or may be included within the processor 120. When the display control module 170 is included within the processor 120, the processor 20 may variously distinguish a user touch inputs to interpret a user's command intentions and perform corresponding operations in response.

When an object 703 displayed on the first display 701 is “touched” or “hovered” over by a user's finger or an electronic pen, and thus an object touch takes place, the processor 120 may distinguish whether the object touch is a general touch or a touch having a specific intention (e.g., a “special” touch).

The processor 120 may execute different operations depending on whether the touch input is the general touch or the touch for the specific intention.

For example, as illustrated in FIG. 7, if a user 704 touches the object 703 displayed on the first display 701 with one finger (e.g., a single touch input), the processor 120 may determine that the touch is to be interpreted as a general touch, and displays no virtual object on the second display 702. On the other hand, if the user 704 touches the object 703 with two fingers (e.g., a multi touch input), the processor 120 determines that the touch input indicates movement of the object 703, and may display a virtual object 705 on the second display 702 in response.

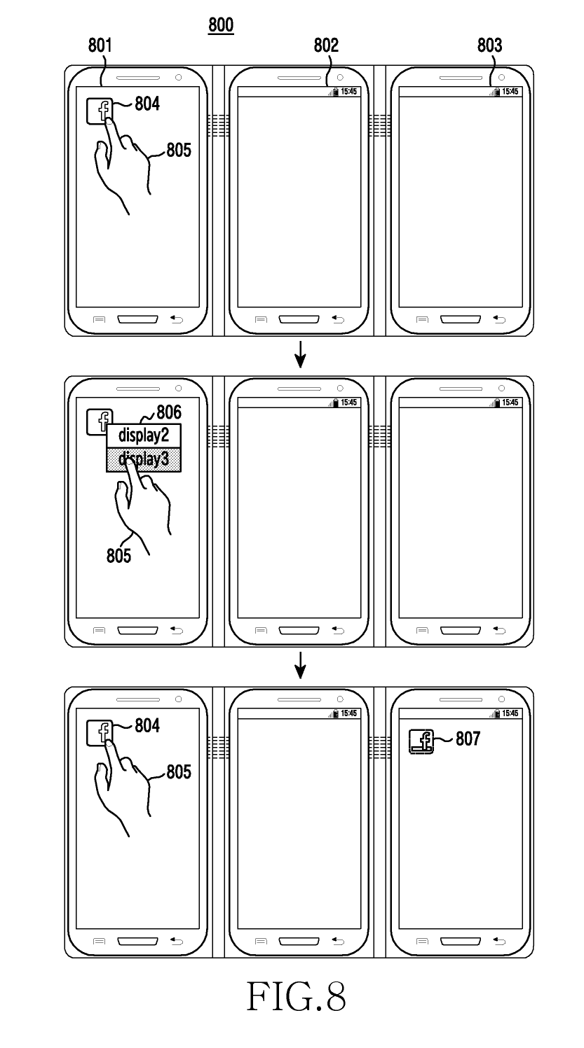

FIG. 8 is another diagram illustrating a virtual object display method according to various example embodiments of the present disclosure.

Referring to FIG. 8, the electronic device 800 may include a first display 801, a second display 802, and a third display 803, which are physically separate but operatively interwork (e.g., operatively coupled) with one another. Any one of the first display 801, the second display 802, and the third display 803 may be configured as a main display, and the others may be configured as sub displays.

The first display 801, the second display 802, and the third display 803 may be controlled by the display control module 170 described earlier with reference to FIG. 1. The display control module 170 may, for example, interwork (e.g., interoperate) with the processor 120, or may be included within the processor 120. In case that the display control module 170 is included within the processor 120, if an object is selected by a user, the processor 120 may display a menu screen of selecting a target display that is to display a virtual object corresponding to the object.

For example, as illustrated in FIG. 8, if a user 805 touches an object 804 displayed on the first display 801, the processor 120 may display a menu 806 of selecting a target display that is to display a virtual object corresponding to the object 804. The selection menu 806 may be variously displayed such as a small-sized pop-up window and icon, and may include simple selection items (i.e., display 2 and display 3) capable of selecting the second display 802 and the third display 803.

If the user 805 uses the selection menu 806 to select the third display 803 as a target display, the processor 120 may display a virtual object 807 on the third display 803. In accordance with this, the user may easily select a display on which a virtual object is to be displayed.

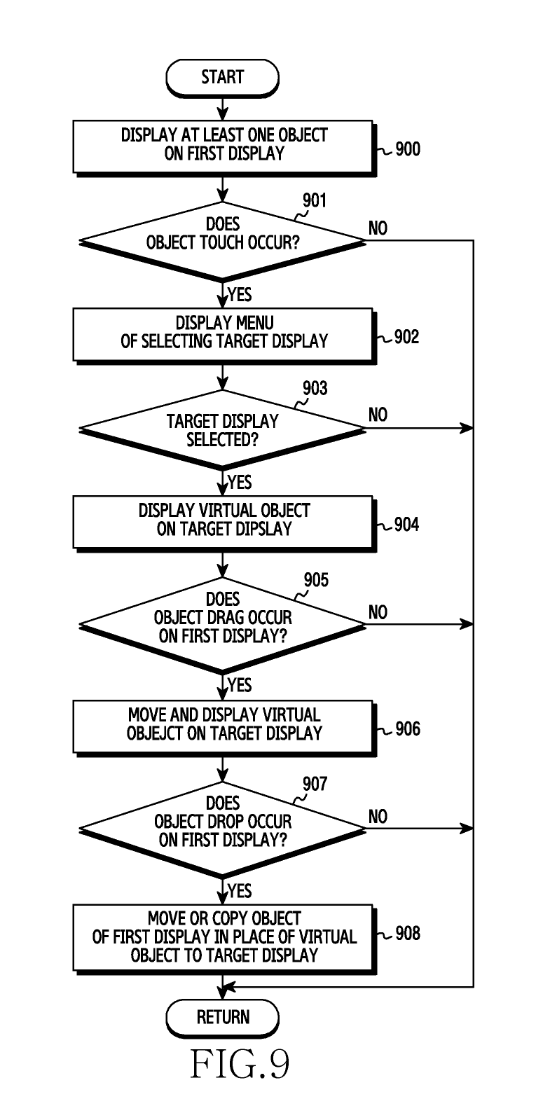

FIG. 9 is another flowchart illustrating an operation of a multi display control method according to various example embodiments of the present disclosure.

Referring to FIG. 9, in operation 900, the processor 120 may display at least one object on a first display. In operation 901, the processor 120 may sense whether the object displayed on the first display is “touched” or “hovered” over by a user's finger or an electronic pen, to determine (or detect) the occurrence or non-occurrence of the object touch.

If the determination result is that the object touch occurs, in operation 902, the processor 120 may display a menu for selecting a target display that is to display a virtual object in response to the object touch. If the target display is selected through the selection menu in operation 903, in operation 904, the processor 120 may display the virtual object on the selected target display.

In operation 905, the processor 120 may sense whether the object touched in the first display is dragged to an arbitrary position of the first display, to determine the occurrence or non-occurrence of the object drag. If the object drag occurs, in operation 906, the processor 120 may interwork or interoperate with the drag, to move the virtual object displayed on the target display to a corresponding position of the target display.

Thereafter, in operation 907, the processor 120 may sense if the object dragged on the first display is dropped, to determine the occurrence or non-occurrence of the object drop. If the determination result is that the object drop occurs, in operation 908, the processor 120 may perform an operation of moving or copying the object to the position of the target display in which the virtual object is displayed.

In accordance with this disclosure, the user may move or copy the object to a corresponding position of the target display, through the operations of touching, dragging and dropping the object on the first display after selecting through a menu screen the target display on which the virtual object is to be displayed.

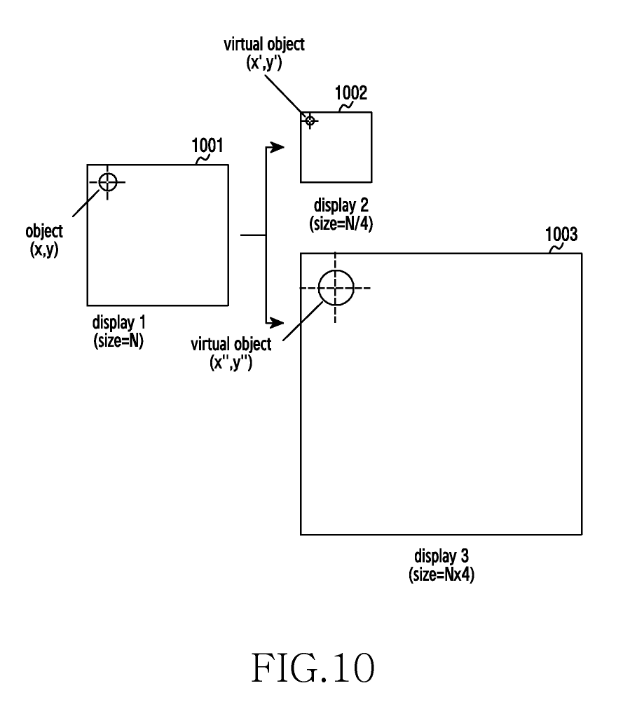

FIG. 10 is an illustrative diagram displaying a virtual object at a different rate according to various example embodiments of the present disclosure.

Referring to FIG. 10, if an object displayed on a first display 1001 is selected (e.g., touched via touch input) by a user's finger or electronic pen, a virtual object corresponding to the selected object may be displayed on any one of a second display 1002 or a third display 1003.

The first display 1001, the second display 1002, and the third display 1003 may have different screen resolutions, respectively. For example, the screen resolution (e.g., N/4) of the second display 1002 may be four times smaller than the screen resolution (e.g., N) of the first display 1001, and the screen resolution (e.g., N×4) of the third display 1003 may be four times larger than the screen resolution (e.g., N) of the first display 1001.

In this case, at least any one of a size and position coordinate (x, y) of the object displayed on the first display 1001 may have a proportional relationship with at least any one of a size and position coordinate (x′, y′) of the virtual object displayed on the second display 1002, and may have a proportional relationship with at least any one of a size and position coordinate (x″, y″) of the virtual object displayed on the third display 1003.

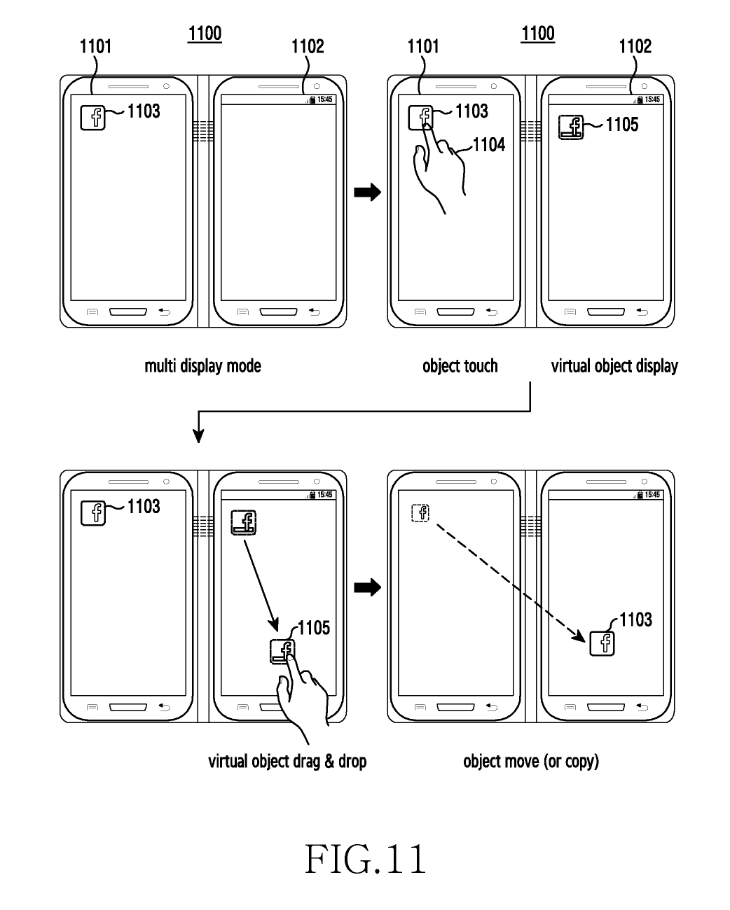

FIG. 11 is another diagram illustrating a multi display control method of an electronic device according to various example embodiments of the present disclosure.

Referring to FIG. 11, the electronic device 1100 may include, for example, various types of electronic devices such as a smartphone or a tablet PC. The electronic device 1100 may include a first display 1101 and a second display 1102, which are physically separate but operatively interwork (e.g., interoperate) with one another.

The first display 1101 may be a main display, and the second display 1102 may be a sub display. Or, inversely, the second display 1102 may be a main display, and the first display 1101 may be a sub display.

The main display and the sub display may be changed by user's selection. Also, for example, one display in which a user's touch is initially detected (while the electronic device 1100 performs a multi display operation) may be designated as a main display, and the other display may thus be designated as a sub display. Other methods may be applied as desired or required.

When one object 1103 is displayed on the first display 1101, and a user 1104 either touches the object 1103 with a finger or electronic pen, or hovers over the object 1103 for more than a predetermined span of time, the processor 120 may create a virtual object 1105 corresponding to the object 1103, and display the virtual object 1105 on the second display 1102.

The virtual object 1105 may be displayed in a specific position of the second display 1102 corresponding to a position of the first display 1101 in which the object 1103 is displayed, and may be displayed in a shape the same or similar to the object 1103. Alternatively, the virtual object 1105 may be displayed variously in a specific shape, color, and brightness that is different from the object 1103.

When the virtual object 1105 displayed on the second display 1102 is selected by a user and then dragged to an arbitrary position of the second display 1102, the processor 120 may perform an operation of interworking (e.g., interoperating) with the drag operation, to move the virtual object 1105 to a corresponding position of the second display 1102.

Thereafter, when the user 1104 performs a dropping operation of releasing the touch of the dragged virtual object 1105, the processor 120 may perform an operation of moving, copying or inserting the object 1103 of the first display 1101 to the position of the virtual object 1105 moved to the corresponding position of the second display 1102.

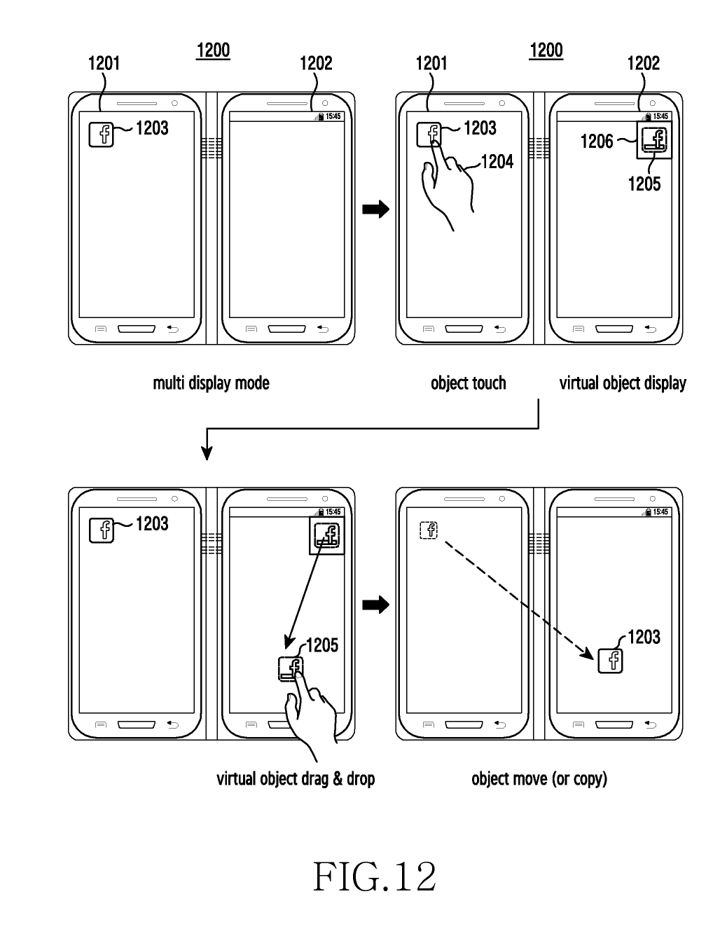

FIG. 12 is a further diagram illustrating a multi display control method of an electronic device according to various example embodiments of the present disclosure.

Referring to FIG. 12, the electronic device 1200 may be, for example, various types of electronic devices such as a smartphone or a tablet PC. The electronic device 1200 may include a first display 1201 and a second display 1202, which are physically separated but operatively interwork with each other.

When one object 1203 is displayed on the first display 1201, and a user 1204 touches the object 1203 displayed on the first display 1201 with a finger or electronic pen, or hovers over the object 1203 for more than a predetermined amount of time, the processor 120 may create a virtual object 1205 corresponding to the object 1203 touched by the user 1204, and display the virtual object 1205 in a specific position 1206 of the second display 1202.

The specific position 1206 may be various positions on a display, such as a right and upper side of the second display 1202, a left and upper side thereof, or a center thereof. The specific position 1206 may be configured in advance, or may be changed by a user, and/or may be automatically changed into an arbitrary different position in accordance with contents displayed on the second display 1202.

For example, the specific position 1206 may be configured to be disposed to the right and upper side of the second display 1202, and may be changed into a different position such as the left and upper side of the second display 1202, such that currently displayed contents or icons are not hidden or overlapped by the virtual object 1205. The virtual object 1205 may be also displayed, for example, in a semitransparent state, such that the currently displayed contents or icon are viewable if overlapping with the virtual object 1205.

When the virtual object 1205 is touched and dragged to an arbitrary position of the second display 1202 by the user, the processor 120 may perform an operation interworking (e.g., interoperating) with the drag operation and move the virtual object 1205 to the position of the second display 1202.

Thereafter, in case that the user 1204 performs a dropping operation of releasing the touch of the dragged virtual object 1205, the processor 120 may perform an operation of moving, copying or inserting the object 1203 of the first display 1201 to the position of the virtual object 1205 moved to the arbitrary position of the second display 1202.

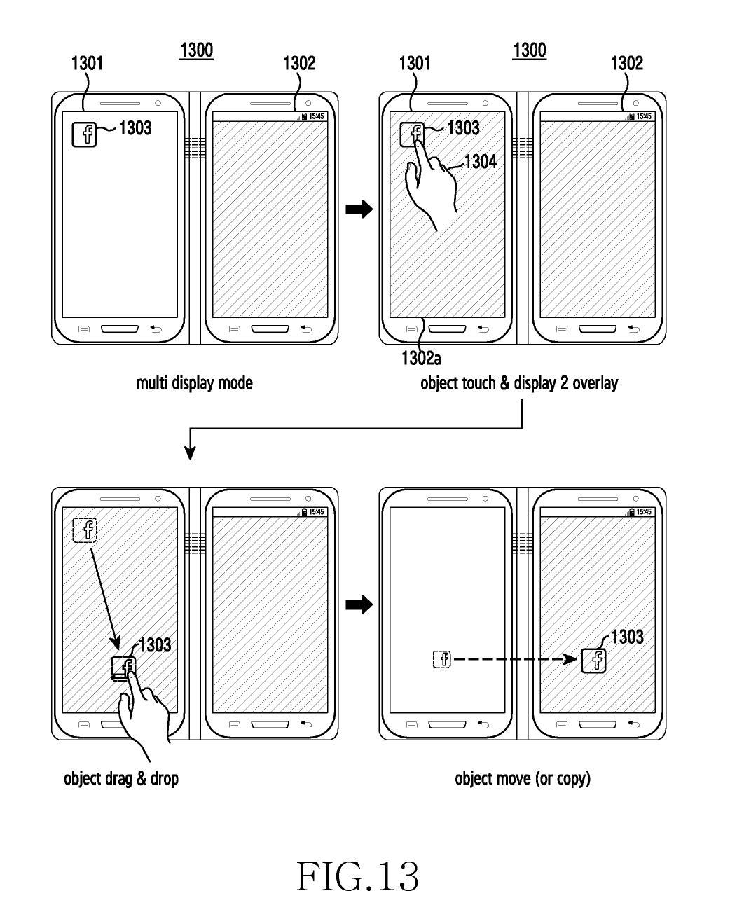

FIG. 13 is another diagram illustrating a multi display control method of an electronic device according to various example embodiments of the present disclosure.

Referring to FIG. 13, the electronic device 1300 may be, for example, various types of electronic devices such as a smartphone or a tablet PC. The electronic device 1300 may include a first display 1301 and a second display 1302, which are physically separate but operatively interwork with each other.

In a state in which arbitrary one object 1303 is displayed on the first display 1301, when a user 1304 touches the object 1303 displayed on the first display 1301 with a finger or electronic pen or hovers over the object 1303 for more than a predetermined period of time, the processor 120 may create a main screen displacing the whole or one part of a current screen 1302a of the second display 1302, and overlay the created main screen on the first display 1301. The main screen of the second display 1302 overlaid on the first display 1301 may be displayed in an opaque state, or may be adjusted to have high transparency such that the main screen does not hide a screen of the first display 1301.

When the selected object 1303 is dragged to an arbitrary position of the main screen 1302a of the second display 1302 (still overlaid on the first display 1301 by the user 1304), the processor 120 may perform an operation interworking and/or interoperating with the drag operation, to move the object 1303 to a position of the main screen 1302a of the second display 1302 overlaid on the first display 1301.

Thereafter, in case that the user 1304 performs a drop operation of releasing the touching of the dragged object 1303, the processor 120 may allow the main screen 1302a of the second display 1302 to disappear from the first display 1301 or to naturally return to the second display 1302, the original state, and may perform an operation of moving, copying or inserting the object 1303 to a position of the second display 1302.

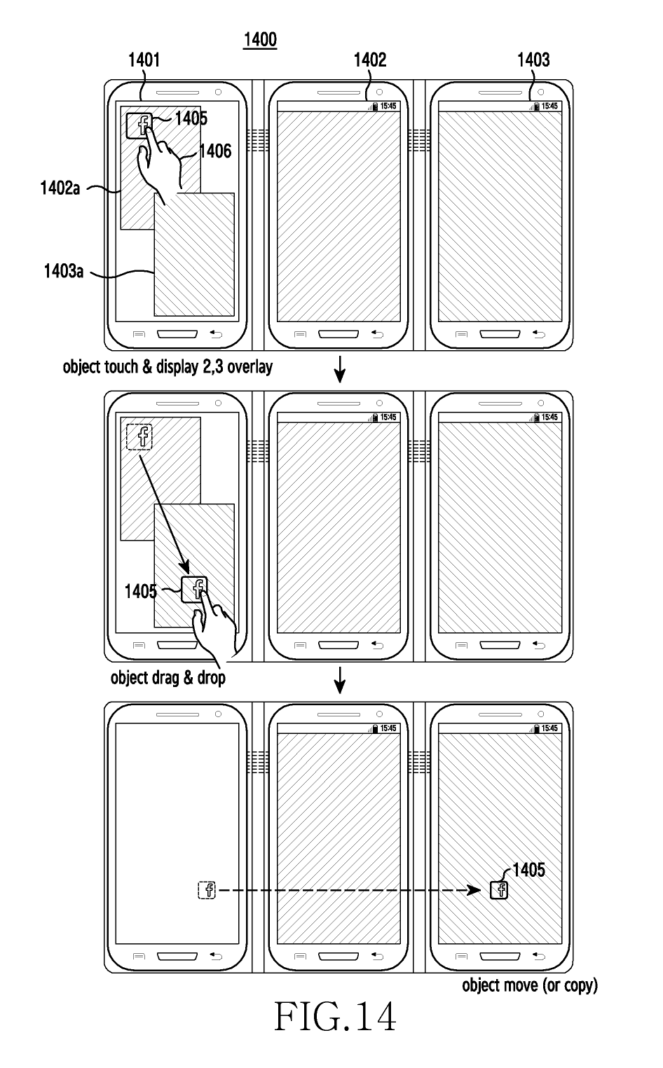

FIG. 14 is a still another diagram illustrating a multi display control method of an electronic device according to various example embodiments of the present disclosure.

Referring to FIG. 14, the electronic device 1400 may be, for example, various types of electronic devices such as a smartphone or a tablet PC. The electronic device 1400 may include a first display 1401, a second display 1402, and a third display 1403, which are physically separate but operatively interwork, interoperate or intercouple with one another.

When one object 1405 is displayed on the first display 1401, and a user 1406 touches the object 1405 displayed on the first display 1401 with a finger or electronic pen or hovers over the object 1405 for more than a predetermined amount of time, the processor 120 may create a main screen displacing a current screen 1402a of the second display 1402 and a current screen 1403a of the third display 1403, and overlay the created main screen on the first display.

When the touched object 1405 is dragged to an arbitrary position of the main screen 1403a of the third display 1403 overlaid on the first display 1401 by the user 1406, the processor 120 may perform an operation interworking or interoperating with the drag operation, to move the object 1405 to the arbitrary position of the main screen 1403a of the third display 1403 overlaid on the first display 1401.

Thereafter, when the user 1406 performs a drop operation releasing the touch on the dragged object 1405, the processor 120 may allow the main screen 1402a of the second display 1402 and the main screen 1403a of the third display 1403 overlaid on the first display 1401 to disappear from the first display 1401, or may perform an operation of moving, copying or inserting the object 1405, for example, to an arbitrary position of the third display 1403.

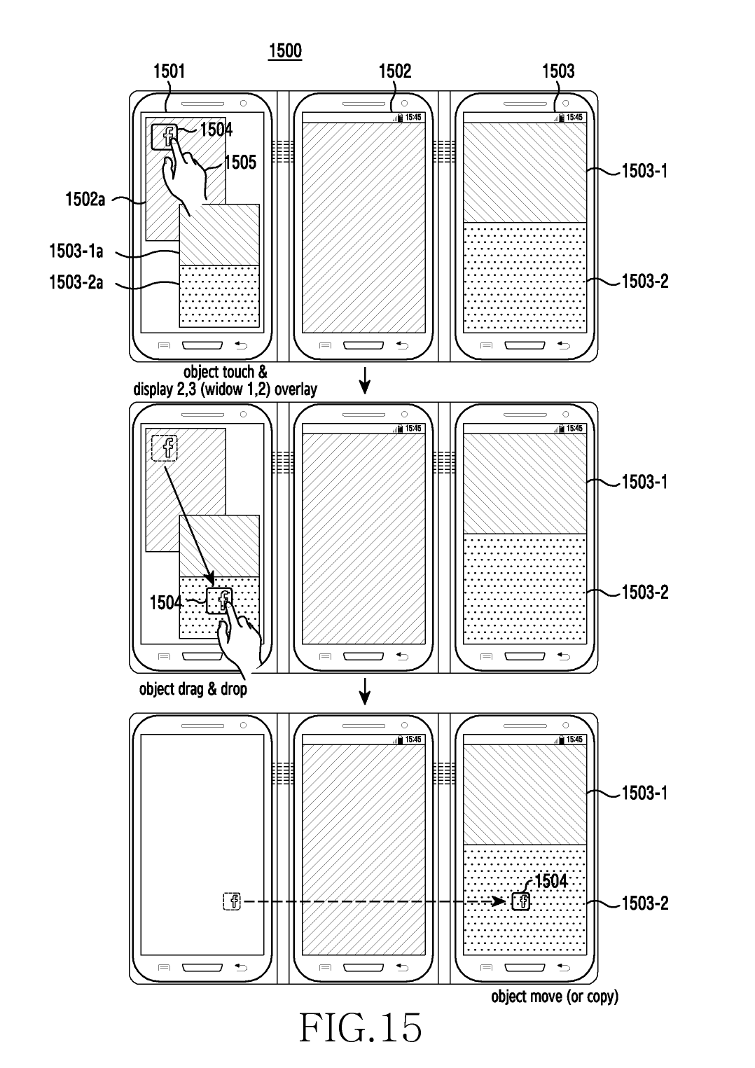

FIG. 15 is a still another diagram illustrating a multi display control method of an electronic device according to various example embodiments of the present disclosure.

Referring to FIG. 15, the electronic device 1500 may include, for example, various types of electronic devices such as a smartphone or a tablet PC. The electronic device 1500 may include a first display 1501, a second display 1502, and a third display 1503, which are physically separate but operatively interwork, interoperate or intercouple with one another.

When one object 1504 is displayed on the first display 1501, and a user 1505 touches the object 1504 displayed on the first display 1501 with a finger or electronic pen, or hovers over the object 1504 for more than a predetermined amount of time, the processor 120 may create a main screen displacing a current screen 1502a of the second display 1502 and a current screen 1503a of the third display 1503, and overlay the created main screen on the first display 1501 in various schemes.

For example, in case that two windows 1503-1 and 1503-2 are displayed on the third display 1503, two windows 1503-1a and 1503-2a may be displayed on the current screen 1503a of the third display 1503 overlaid on the first display 1501.

When the touched object 1504 is dragged to an arbitrary position of the main screen 1503-2a of the third display 1503 overlaid on the first display 1501 by the user 1505, the processor 120 may perform an operation interworking or interoperating with the drag operation to move the object 1504 to the arbitrary position of the main screen 1503-2a of the third display 1503 overlaid on the first display 1501.

Thereafter, when the user 1505 performs a drop operation releasing the touch of the dragged object 1504, the processor 120 may allow the main screen 1502a of the 15 second display 1502 and the main screen 1503a of the third display 1503 overlaid on the first display 1501 to disappear from the first display 1501, and/or may perform an operation of moving, copying or inserting the object 1504, for example, to a corresponding position of the second window 1503-2 of the third display 1503.

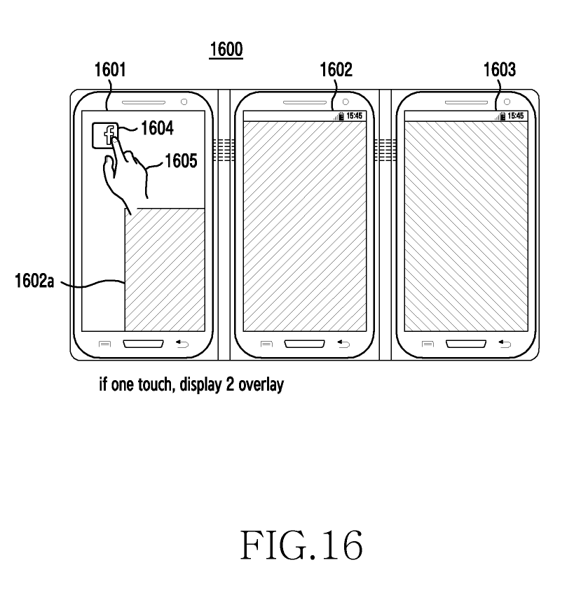

FIG. 16 is a still another diagram illustrating a multi display control method of an electronic device according to various example embodiments of the present disclosure.

Referring to FIG. 16, the electronic device 1600 may be, for example, various types of electronic devices such as a smartphone or a tablet PC. The electronic device 1600 may include a first display 1601, a second display 1602, and a third display 1603, which are physically separate but operatively interwork, interoperate or intercouple with one another.

When one object 1604 is displayed on the first display 1601, and a user 1605 touches the object 1604 displayed on the first display 1601 with a finger or electronic pen or hovers over the object 1604 for more than a predetermined amount of time, the processor 120 may create a main screen operatively displacing any one of a current screen 1602a of the second display 1602 and a current screen 1603a of the third display 1603, and overlay the created main screen on the first display 1601 in various schemes.

For example, if the object touch is interpreted as a general touch input using one finger of a user, the processor 120 may create a main screen operatively displacing the current screen 1602a of the second display 1602, and overlay the created main screen on the first display 1601 in various schemes.

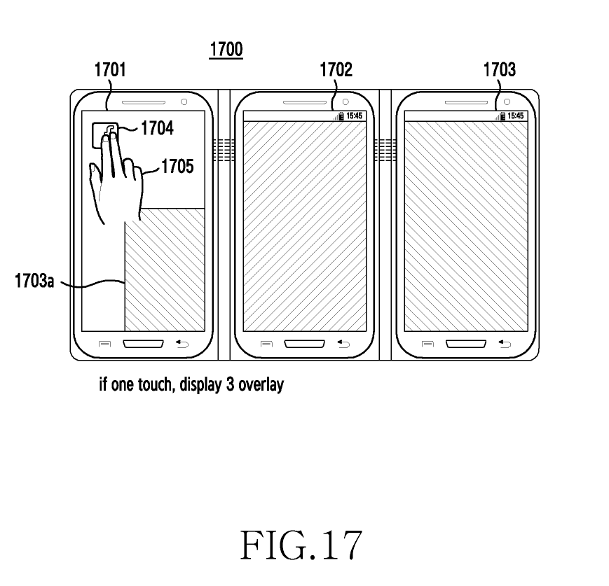

FIG. 17 is a still another diagram illustrating a multi display control method of an electronic device according to various example embodiments of the present disclosure.

Referring to FIG. 17, the electronic device 1700 may be, for example, various types of electronic devices such as a smartphone or a tablet PC. The electronic device 1700 may include a first display 1701, a second display 1702, and a third display 1703, which are physically separate but operatively interwork, interoperate or intercouple with one another.

When one object 1704 is displayed on the first display 1701, and a user 1705 touches the object 1704 displayed on the first display 1701 with a finger or electronic pen that hovers over the object 1704 for more than a predetermined amount of time, the processor 120 may create a main screen operatively displacing any one of a current screen 1702a of the second display 1702 and a current screen 1703a of the third display 1703, and overlay the created main screen on the first display 1701.

For example, if the object touch is identified as a special touch input using two fingers of a user, the processor 120 may create a main screen operatively displacing the current screen 1703a of the third display 1703, and overlay the created main screen on the first display 1701 in various schemes.

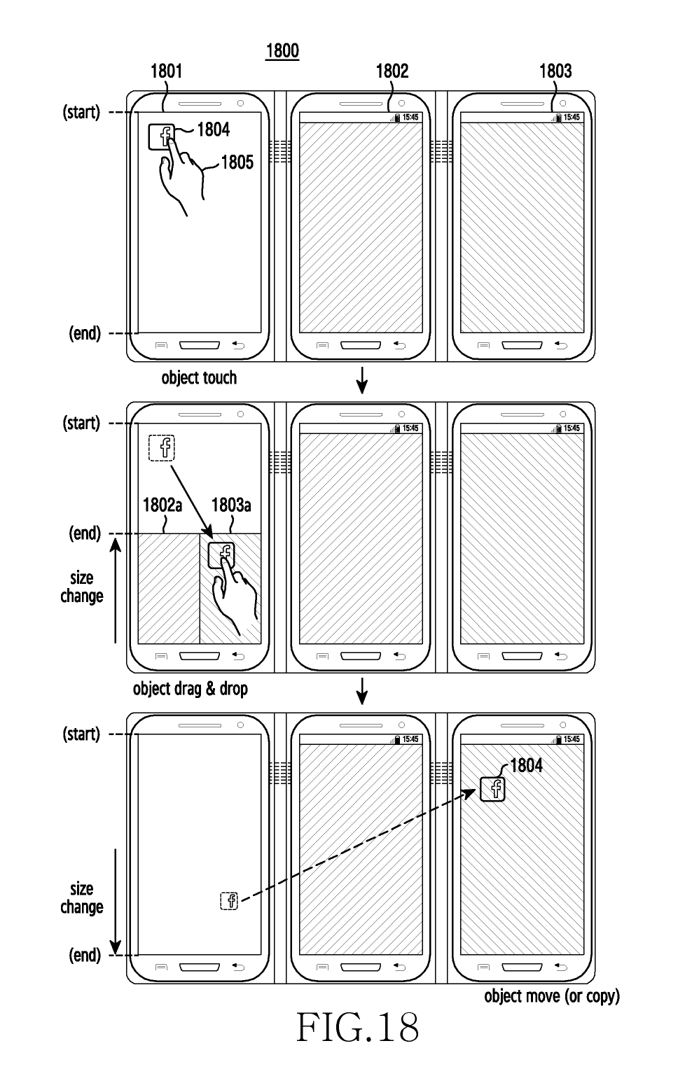

FIG. 18 is a still another diagram illustrating a multi display control method of an electronic device according to various example embodiments of the present disclosure.

Referring to FIG. 18, the electronic device 1800 may be, for example, various types of electronic devices such as a smartphone or a tablet PC. The electronic device 1800 may include a first display 1801, a second display 1802, and a third display 1803, which are physically separate but operatively interwork, interoperate or intercouple with one another.

When one object 1804 is displayed on the first display 1801, and a user 1805 touches the object 1804 displayed on the first display 1801 with a finger or electronic pen, or hovers over the object 1804 for more than a predetermined amount of time, the processor 120 may create a screen operatively displacing a current screen 1802a of the second display 1802 and a current screen 1803a of the third display 1803, and overlay the created screen on the first display 1801 in various schemes.

For example, the main screen 1802a of the second display 1802 and the main screen 1803a of the third display 1803 may be displayed in a partial region (e.g., a lower region) of the first display 1801. A screen of the first display 1801 may be changed in size to avoid overlap with the main screens 1802a and 1803a of the first and second displays 1801 and 1802. The main screens 1802a and 1803a may be displayed in an opaque state in a specific region of the first display 1801.

When the touched object 1804 is dragged to an arbitrary position of the main screen 1803a of the third display 1803 overlaid on the first display 1801 by the user 1805, the processor 120 may perform an operation interworking with the drag operation to move the object 1804 to the corresponding position of the main screen 1803a of the third display 1803 overlaid on the first display 1801.

Thereafter, when the user 1805 performs a drop operation releasing the touch of the dragged object 1804, the processor 120 may allow the main screens 1802a and 1803a displayed in a specific region of the first display 1801 to disappear from the first display 1801, and restore the original screen size while performing an operation of moving, copying or inserting the object 1804, for example, to a corresponding position of the third display 1803.

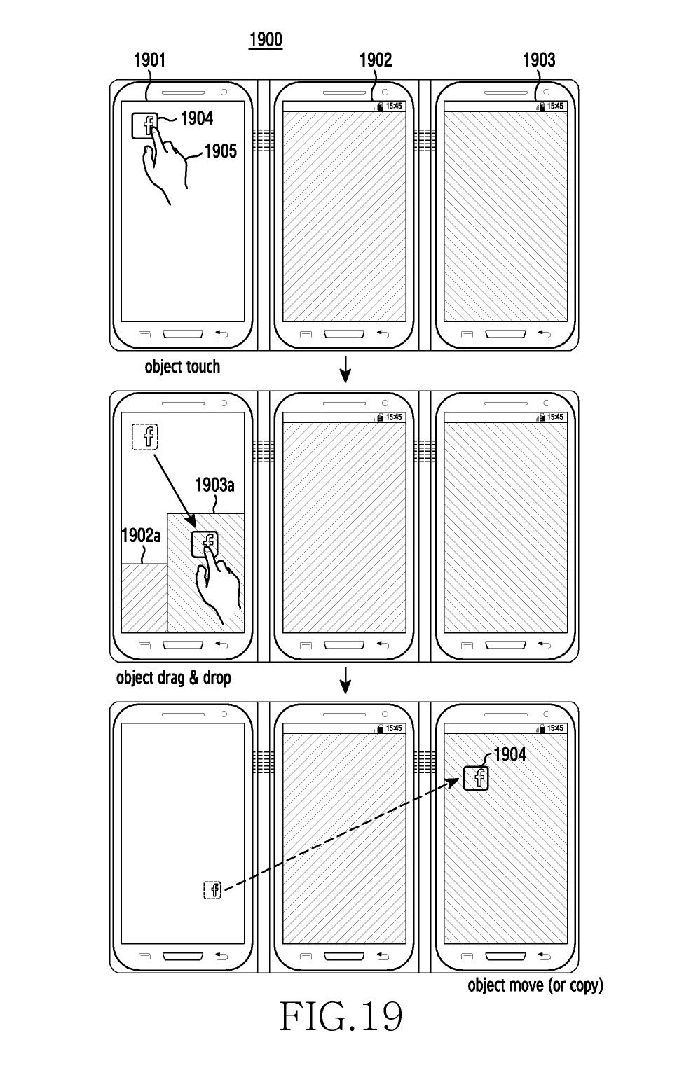

FIG. 19 is a still another diagram illustrating a multi display control method of an electronic device according to various example embodiments of the present disclosure.

Referring to FIG. 19, the electronic device 1900 may be, for example, various types of electronic devices such as a smartphone or a tablet PC. The electronic device 1900 may include a first display 1901, a second display 1902, and a third display 1903, which are physically separated but operatively interwork, interoperate or intercouple with one another.

When one object 1904 is displayed on the first display 1901, and a user 1905 touches the object 1904 displayed on the first display 1901 with a finger or electronic pen, or hovers over the object 1904 for more than a predetermined amount of time, the processor 120 may create a screen operatively displacing a current screen 1902a of the second display 1902 and a current screen 1903a of the third display 1903, and overlay the created screen on the first display 1901.

For example, in case that the touched object 1904 is a high-definition photo image and the third display 1903 has a higher resolution than the second display 1902, the processor 120 may display the main screen 1903a of the third display 1903 suitable to the high-definition photo image and the main screen 1902a of the second display 1902 such that the main screen 1903a is displayed larger relative to the main screen 1902a. Or, the processor 120 may overlay the main screen 1903a of the third display 1903 suitable to the high-definition photo image, on the first display 1901 in various schemes.

When the touched object 1904 is dragged to an arbitrary position of the main screen 1903a of the third display 1903 overlaid on the first display 1901 by the user 1905, the processor 120 may perform an operation of interworking with the drag operation, to move the object 1904 to the corresponding position of the main screen 1903a of the third display 1903 overlaid on the first display 1901.

Thereafter, when the user 1905 performs a drop operation releasing the touch of the dragged object 1904, the processor 120 may cause the main screens 1902a and 1903a displayed in a specific region of the first display 1901 to disappear from the first display 1901, and may perform an operation of moving, copying or inserting the object 1904, for example, to an arbitrary position of the third display 1903.

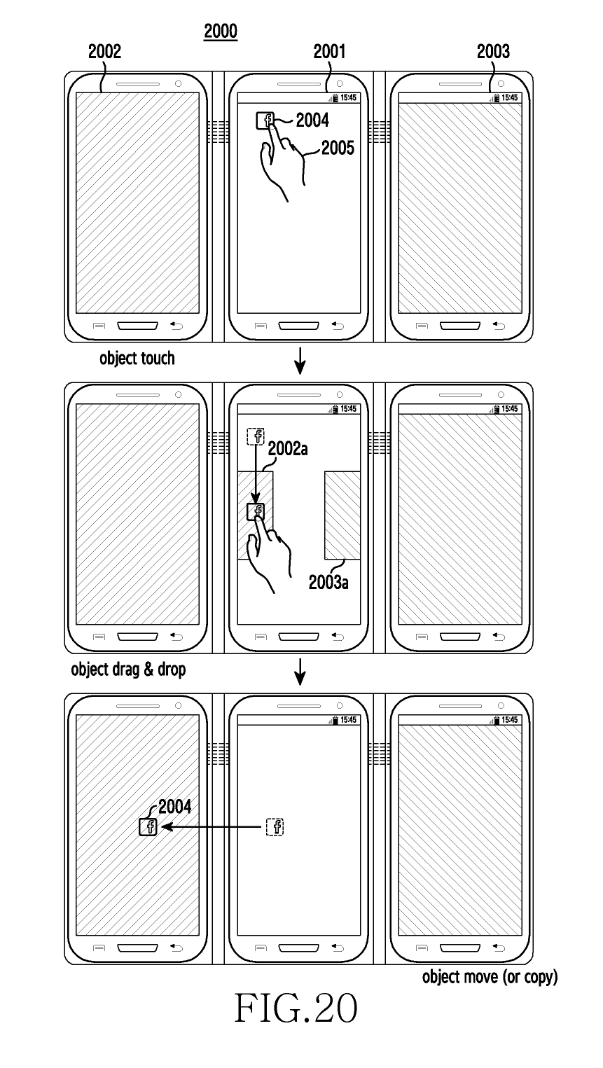

FIG. 20 is a still another diagram illustrating a multi display control method of an electronic device according to various example embodiments of the present disclosure.

Referring to FIG. 20, the electronic device 2000 may be, for example, various types of electronic devices such as a smartphone or a tablet PC. The electronic device 2000 may include a first display 2001, a second display 2002, and a third display 2003, which are physically separate but operatively interwork, interoperate with one another.

According to various example embodiments of the present disclosure, at the time of object movement by user's selection, the second display 2002 and the third display 2003 connected with the main electronic device 2000 may create operatively displacing main screens in consideration of their relative positions with the main electronic device 2000.

When one object 2004 is displayed on the first display 2001, and a user 2005 touches the object 2004 displayed on the first display 2001 with a finger or electronic pen or hovers more than a certain time, the processor 120 may create a screen operatively displacing a current screen 2002a of the second display 2002 and a current screen 2003a of the third display 2003, and overlay the created screen on the first display 2001 in various schemes.

The overlaid main screens may be arranged in accordance with their position and direction in terms of their physical arrangement within the main electronic device 2000. For example, in case that the second display 2002 is connected to a left side of the main electronic device 2000 and the third display 2003 is connected to a right side of the main electronic device 2000, the main screen 2002a of the second display 2002 may be displayed in one part of the left side of the first display 2001, and the main screen 2003a of the third display 2003 may be displayed in one part of the right side of the first display 2001. Or, any one of the main screens 2002a and 2003a may be displayed in one part of the left side or right side of the first display 2001.

When the touched object 2004 is dragged to an arbitrary position of the main screen 2002a of the second display 2002 overlaid on the first display 2001 by the user 2005, the processor 120 may perform an operation interworking with the drag operation to move the object 2004 to the corresponding position of the main screen 2002a of the 15 second display 2002 overlaid on the first display 2001.

Thereafter, when the user 2005 performs a drop operation releasing touch of the dragged object 2004, the processor 120 may cause the main screens 2002a and 2003a displayed in a specific region of the first display 2001 to disappear from the first display 2001, and perform an operation moving, copying or inserting the object 2004, for example, to a corresponding position of the second display 2002.

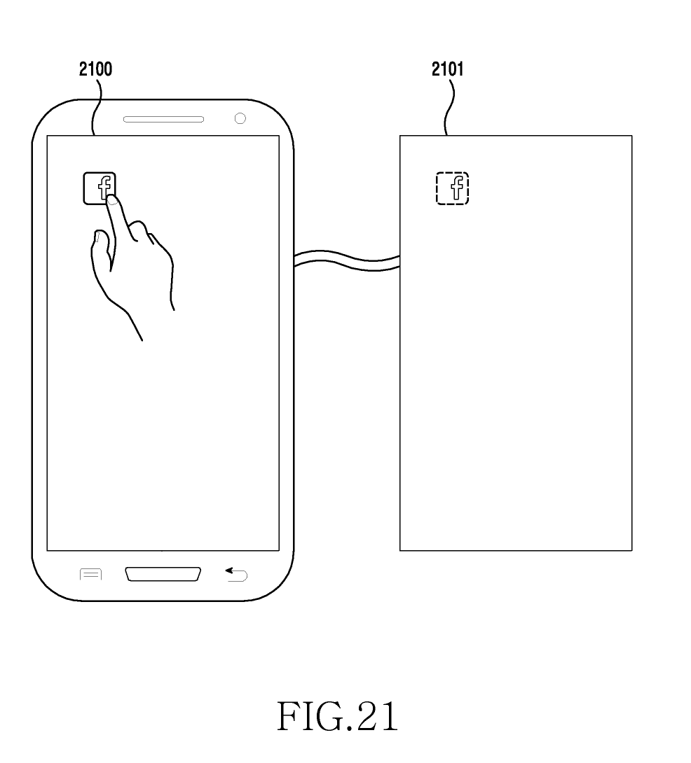

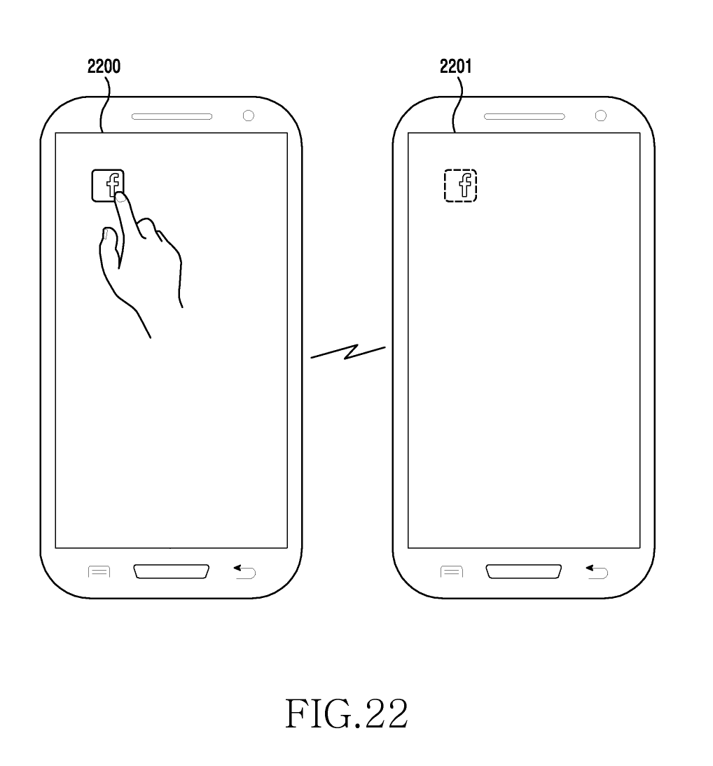

FIG. 21 and FIG. 22 are illustrative diagrams in which a plurality of displays operatively interwork with one another in accordance with various example embodiments of the present disclosure.

Referring to FIG. 21, for example, a main electronic device 2100 such as a smartphone may be wired or wirelessly connected with at least one or more sub displays 2101 to operatively interwork with the sub display 2101.

Referring to FIG. 22, a main electronic device 2200 such as a smartphone may be wired or wirelessly connected with at least one or more other electronic devices 2201 such as smartphones to operatively interwork with the electronic device 2201. The other electronic devices 2201 may be smart TVs or tablet PCs. Other various example embodiments are possible.

A multi display control method according to various example embodiments of the present disclosure may be not applied to one electronic device with a plurality of displays but also may be identically or similarly applied different several electronic devices interworking with one another through wired or wireless communication.

According to various example embodiments of the present disclosure, for example, if using a multi display physically separated but operatively interworking, a user may perform an object selection (e.g., touch) and a drag and drop operation on a first display, to easily move or copy an object displayed on the first display, to a second display.

According to various example embodiments of the present disclosure, for example, if using a multi display physically separated but operatively interworking, a user may select (e.g., touch) an object displayed on a first display to variously overlay on the first display a main screen displacing the whole or partial screen of a second display, and may drag and drop the object to the main screen to easily move or copy the object displayed on the first display, to the second display.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

While the disclosure has been shown and described with reference to certain disclosed embodiments thereof, it will be understood by those skilled in the art that various changes in form and details may be made therein without departing from the disclosure as defined by the appended claims.

What is claimed is:

1. A method for an electronic device, comprising:
detecting, by a processor of the electronic device, a selection of an object displayed on a first display operatively coupled to the electronic device and displaying a virtual object on a second display operatively coupled to the electronic device in response to the selection;
detecting a dragging of the selected object on the first display, and moving the virtual object on the second display in response to the detected dragging; and
if a release of the dragged selected object is detected on the first display moving or copying the object to the second display.

2. The method of claim 1, wherein the first display and the second display are physically separate but operatively coupled with each other via wired or wireless communication.

3. The method of claim 1, wherein the selection of the object is executed by at least one of a touch input or a hover input.

4. The method of claim 1, wherein displaying the virtual object on the second display further comprises displaying the virtual object in a position of the second display corresponding to a position of the first display where the object is selected.

5. The method of claim 1, wherein moving the virtual object on the second display further comprises moving the virtual object to a position of the second display corresponding to a position of the first display to which the selected object is dragged.

6. The method of claim 1, wherein, if the dragged selected object is released on the first display, moving or copying further comprises moving or copying the object to a position of the second display where the virtual object is displayed.

7. The method of claim 1, wherein the virtual object comprises at least one of a shape or color correlating to at least one of a shape or color of the object.

8. The method of claim 1, wherein a display position of the virtual object on the second display is based on at least a display position of the object on the first display, and respective screen resolutions of the first display and the second display.

9. The method of claim 1, further comprising displaying a menu screen for selecting a display on which the virtual object is to be displayed.

10. The method of claim 9, further comprising displaying the virtual object on the display selected from the menu.

11. An electronic device, comprising:
a processor for controlling multiple displays, configured to:
detect a selection of an object displayed on a first display operatively coupled to the electronic device, and display a virtual object on a second display operatively coupled to the electronic device in response to the selection;
detect a dragging of the selected object on the first display, moving the virtual object on the second display in response to the detected dragging; and
if a release of the dragged selected object is detected on the first display, move or copy the object to the second display.

12. The device of claim 11, wherein the first display and the second display are physically separate but operatively coupled with each other via wired or wireless communication.

13. The device of claim 11, wherein the selection of the object is executed by at least one of a touch input or hover input.

14. The device of claim 11, wherein displaying the virtual object on the second display in a position of the second display corresponding to a position of the first display where the object is selected.

15. The device of claim 11, wherein moving the virtual object on the second display further comprises moving the virtual object to a position of the second display corresponding to a position of the first display where the selected object is dragged.

16. The device of claim 11, wherein, if the dragged selected object is released on the first display, moving or copying further comprises moving or copying the object to a position of the second display where the virtual object is displayed.

17. The device of claim 11, wherein the virtual object comprises at least one of a shape or color correlating to at least one of a shape or color of the object.

18. The device of claim 11, wherein the processor determines a display position of the virtual object on the second display is based on a display position of the object on the first display and respective screen resolutions of the first display and the second display.

19. The device of claim 11, wherein the processor is further configured to display a menu screen for selecting a display on which the virtual object is to be displayed, and displaying the virtual object on the display selected from the menu.

20. A non-transitory computer-readable storage medium storing program instructions executable by a processor of an electronic device to:
detect a selection of an object displayed on a first display operatively coupled to the electronic device, and display a virtual object on a second display operatively coupled to the electronic device in response to the selection;
detect a dragging of the selected object on the first display, moving the virtual object on the second display in response to the detected dragging; and
if a release of the dragged selected object is detected on the first display, moving or copying the object to the second display.
